(19) United States
(12) Patent Application Publication
(10) Pub. No.: US 2016/0018746 A1
(43) Pub. Date: Jan. 21, 2016

(54) ELECTROPHOTOGRAPHIC PHOTORECEPTOR, ELECTROPHOTOGRAPHIC PHOTORECEPTOR CARTRIDGE, AND IMAGE FORMATION DEVICE

(71) Applicant: Mitsubishi Chemical Corporation, Tokyo (JP)

(72) Inventors: Yuka Nagao, Odawara-shi (JP); Mitsuo Wada, Odawara-shi (JP)

(73) Assignee: Mitsubishi Chemical Corporation, Tokyo (JP)

(21) Appl. No.: 14/866,240

(22) Filed: Sep. 25, 2015

Related U.S. Application Data
(63) Continuation of application No. PCT/JP2014/058137, filed on Mar. 24, 2014.

(30) Foreign Application Priority Data
Mar. 25, 2013 (JP) 2013-062631

(51) Int. Cl. G03G 5/06; G03G 15/00

(52) U.S. Cl. CPC G03G 5/0614; G03G 15/75; G03G 5/0662

(57) ABSTRACT

An electrophotographic photoreceptor comprising at least a photosensitive layer on a conductive support, wherein the photosensitive layer contains a specific compound and a specific charge-transporting substance.

### TECHNICAL FIELD

The present invention relates to an electrophotographic photoreceptor, an electrophotographic photoreceptor cartridge, and an image formation device. In particular, the present invention relates to an electrophotographic photoreceptor, an electrophotographic photoreceptor cartridge and an image formation device excellent in gas resistance and durability and having good responsiveness and electric characteristics.

### BACKGROUND ART

Electrophotography is excellent in instantaneous operability and provides high-quality images, and is therefore widely used in the field of copiers, various printers, printing machines, etc. As the electrophotographic photoreceptor that is the core in electrophotography, used is an electrophotographic photoreceptor that uses an organic photoconductive substance having the advantages of being free of pollution, easy to form into films and easy to produce (hereinafter this may be simply referred to as “photoreceptor”).

As the layer configuration of the organic photoreceptor, there are known a so-called single-layer photoreceptor in which a charge-generating substance is dispersed in a binder resin, and a so-called laminate-type photoreceptor comprising, as laminated therein, a charge generation layer and a charge transport layer. Regarding the laminate-type photoreceptor, an efficient charge-generating substance and a charge-transporting substance are separately put in different layers and the two layers are combined in a most suitable manner to give a highly-sensitive and stable photoreceptor, and the latitude in selecting the materials for the layers is broad and the characteristics of the layers are easy to control, and for these reasons, the laminate-type photoreceptor is much used in the art. The single-layer photoreceptor is somewhat inferior to the laminate-type photoreceptor in point of the electric characteristics thereof, and the latitude in selecting the materials for it is narrow; but the single-layer photoreceptor realizes high resolution since charges are generated in the vicinity of the surface of the photoreceptor and, in addition, even though the photosensitive layer thereof is thickened, there does not occur a problem of image blurring, and therefore the layer may be thickened to enhance the durability of the printing performance of the photoreceptor. The other advantages of the single-layer photoreceptor are that the coating process is simple, and the photoreceptor is free from a problem of interference fringes derived from the conductive substrate (support) and from a problem of core pipe defects, for which, consequently, usable are inexpensive substrates such as un-machined pipes and the like, therefore realizing cost reduction.

The electrophotographic photoreceptor is repeatedly used in an electrophotographic process that comprises a cycle of charging, photoexposure, development, transfer, cleaning, neutralization, etc., and therefore during the process, the photoreceptor receives various stresses and is thereby deteriorated. Of these, chemical deterioration is, for example, such that strongly-oxidative ozone and NOx generated in a so-called corona charger as a charge may give damage to the photosensitive layer, and during repeated use, charging capability of the photoreceptor lowers and the residual potential thereof increases, or that is, the electrical stability of the photoreceptor worsens and accordingly, there may occur a problem of image failure. These are largely derived from the chemical deterioration of the charge-transporting substance contained much in the photosensitive layer.

Further, with the recent speed-up process of electrophotography, high sensitivity and high-speed responsivity are essential in the art. Of those, for realizing the high sensitivity, not only optimization of the charge-generating substance but also development of a charge-transporting substance that matches it well would be necessary; and for realizing high-speed responsivity, it would be necessary to develop a charge-transporting substance that secures a high mobility and realizes a sufficient low residual potential during photoexposure.

Moreover, in addition to the above-mentioned necessary performance of the charge-transporting substance, the photoreceptor using the substance is also required to satisfy various characteristics that the photosensitivity is high, the charging performance is sufficient, the dark decay after photoexposure is low, the residual potential is low, the responsivity is good, and the stability of these characteristics in repeated use is high, and in addition to these basic characteristics, the photoreceptor is further required to satisfy other various characteristics, as described below, from the viewpoint of the practical use thereof.

One is toughness against mechanical stress. Regarding the mechanical stress, the photoreceptor is rubbed against a cleaning blade, a magnetic brush or the like, and is brought into contact with a developer and paper, whereby the surface of the photosensitive layer is worn and scratched, thereby causing image defects. Such mechanical deterioration directly worsens the image quality, and is therefore a significant factor of limiting the life of the photoreceptor. Specifically, for developing a high-quality and long-life photoreceptor, improving the chemical durability of the photosensitive layer and also increasing the mechanical characteristics (wear resistance, abrasion resistance) thereof are indispensable conditions.

In general, such mechanical durability of a photoreceptor is largely attributable to the binder resin to be used therein. In place of a polycarbonate resin heretofore used in photoreceptors, a polyester resin more excellent in mechanical durability has become much used recently (for example, seen PTL 1). However, in point of electrical characteristics, a polyester resin is generally inferior to a polycarbonate resin, and therefore for obtaining high-performance photoreceptors, the amount of the charge-transporting substance therein may be increased, which, however, is problematic in that the film strength is lowered and the layer would readily peel away from the photoreceptor. Consequently, a photoreceptor is planned using a charge-transporting substance of which the charge transportability is high, the ionization potential is extremely low and the residual potential is therefore low (for example, see PTL 2 and 3). However, in general, a compound having a low ionization potential is readily oxidized and would be therefore significantly deteriorated by the oxidizing gas to be generated inside machines (for example, see PTL 4). Not only such a defect, but also there would be another defect that, when the constituent substance is an organic material, it would readily conduct gas and water therethrough and would be thereby more readily deteriorated by gas (for example, see PTL 5). For preventing these, in general, an antioxidant is added. As examples of the antioxidant, there are known hindered phenols, thioethers, phosphorus-containing compounds, hindered amines, etc. Of those, hindered phenols are much used in photoreceptor as highly effective, providing few untoward effects, and inexpensive. Further, it is known that specific amine compounds can effectively act as vapor-resistant compounds (for example, PTL 6 and 7).

### CITATION LIST

### Patent Literature

### PTL 1: JP-A 2006-53549

### PTL 2: Japanese Patent 2940502

### PTL 3: Japanese Patent 3694604

### PTL 4: Japanese Patent 2644278

### PTL 5: JP-A 9-265194

### PTL 6: JP-A 3-172852

### PTL 7: JP-A 2004-199051

### SUMMARY OF INVENTION

### Technical Problem

In case where a charge-transporting substance having a high mobility and a low residual potential, such as that described in PTL 2, is selected for providing a high-performance photoreceptor excellent in electric characteristics, hardly causing chemical deterioration and excellent in mechanical durability for high-speed printers capable of realizing high-quality images and free from troublesome and frequent maintenance, the chemical durability of charge-transporting substance against oxidizing gas is poor, and therefore in the case, the above-mentioned hindered phenol-type antioxidant could not provide a sufficient effect. When the amount of the substance to be added is increased expecting a higher effect, immediately the residual potential would increase and the film strength would lower.

On the other hand, the high-performance charge-transporting substance having an extremely low ionization potential, such as that described in PTL 2, weakens the packing performance of the photoreceptor film and would cause significant charging reduction and residual potential increase by oxidizing gas. Further, as a result of the present inventors' investigation, it has been known that the resistance value of the photoreceptor surface owing to energizing deterioration or optical fatigue in repeated use of photoreceptors would greatly fluctuate and, as a result, there occurs a problem of image failures of image blurring and worsening of dot reproducibility.

The present invention has been made in consideration of the above-mentioned problems. Specifically, an object of the present invention is to provide an electrophotographic photoreceptor excellent in mechanical durability, having a high mobility and a low residual potential, excellent in chemical durability against potential oxidizing gas, and undergoing little surface resistance reduction owing to energizing deterioration or optical fatigue, and to provide a process cartridge and an image formation device using the electrophotographic photoreceptor.

### Solution to Problem

The present inventors have assiduously studied a combination of a charge-transporting substance and an additive such as an antioxidant or the like to be used in a photosensitive layer and, as a result, have found that, when a sufficiently bulky charge-transporting substance having a specific structure and having charge transportability and a specific amine compound are used, then a high-performance photoreceptor capable of providing a print of a sharp image within an extremely short period of time and excellent in durability can be obtained, and have completed the present invention.

[1] An electrophotographic photoreceptor comprising at least a photosensitive layer on a conductive support, wherein the photosensitive layer contains a compound represented by the following formula (1) and a charge-transporting substance represented by the following formula (2):

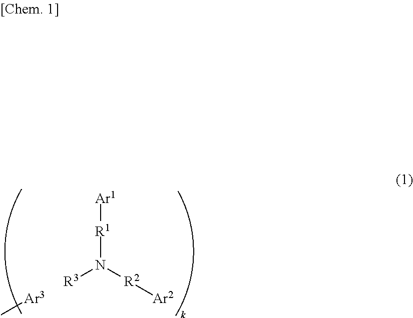

(In the formula (1), R¹, R² and R³ each independently represent an alkylene group having 3 or less carbon atoms and optionally having a substituent, Ar¹ and Ar² each independently represent a hydrogen atom, an alkyl group optionally having a substituent, or an aryl group optionally having a substituent, Ar³ represents an aryl group optionally having a substituent, and k indicates an integer of 1 or 2.)

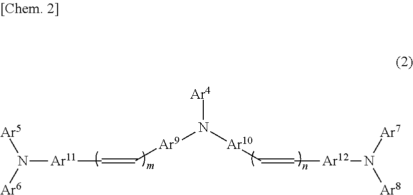

(In the formula (2), Ar⁴ to Ar⁸ each independently represent an aryl group optionally having a substituent, Ar⁹ to Ar¹² each independently represent an arylene group optionally having a substituent, and m and n each independently indicate an integer of from 1 to 3.)
[2] The electrophotographic photoreceptor according to the [1], wherein, in the formula (2), Ar⁴ to Ar⁸ each independently represent an aryl group optionally having an alkyl group or an alkoxy group, Ar⁹ to Ar¹² each independently represent a 1,4-phenylene group optionally having a substituent, and m and n are 1.)
[3] The electrophotographic photoreceptor according to the [1] or [2], wherein, in the formula (2), Ar⁴ represents an aryl group having an alkoxy group, an aryloxy group or an aralkyloxy group, and Ar^{y} to Ar⁸ each independently represent an aryl group optionally having an alkyl group.
[4] The electrophotographic photoreceptor according to any one of the [1] to [3], wherein an amount of the compound represented by the formula (1) is from 0.03 parts by mass to 5 parts by mass relative to 100 parts by mass of a total amount of the charge-transporting substance.
[5] The electrophotographic photoreceptor according to any one of the [1] to [4], wherein the charge-transporting substance represented by the formula (2) is one to be obtained through coupling reaction of a halogen atom-having triphenylamine derivative and an aniline compound.
[6] The electrophotographic photoreceptor according to any one of the [1] to [5], wherein the charge-transporting substance represented by the formula (2) contains palladium.
[7] An electrophotographic cartridge comprising the electrophotographic photoreceptor of any one of the [1] to [6], and at least one means selected from a charging means of charging the electrophotographic photoreceptor, an imagewise exposure means of imagewise exposing the charged electrophotographic photoreceptor to light to form an electrostatic latent image, a development means of developing the electrostatic latent image with a toner, a transfer means of transferring the toner to a transferred medium, and a cleaning means of collecting the toner having adhered to the electrophotographic photoreceptor.
[8] An image formation device comprising the electrophotographic photoreceptor of any one of the [1] to [6], a charging means of charging the electrophotographic photoreceptor, an exposure means of exposing the charged electrophotographic photoreceptor to light to form an electrostatic latent image, a development means of developing the electrostatic latent image with a toner, a transfer means of transferring the toner to a transferred medium, and a fixation means of fixing the toner transferred to the transferred medium.

### Advantageous Effects of Invention

The photoreceptor using the charge-transporting substance of the present invention has excellent electric characteristics and mechanical characteristics. Further, the photoreceptor contains an amine compound having a specific structure and is therefore a high-performance photoreceptor excellent in chemical durability not detracting from the other characteristics. When used in printers and copying machines, the electrophotographic photoreceptor of the type realizes sharpness of images in high-speed printing and stability thereof in continuous printing, therefore securing stable image formation in any and every environment. In addition, the present invention provides an electrophotographic cartridge and an image formation device capable of realizing good dot reproducibility without any image blurring in printing.

The image formation device and the drum cartridge using the photoreceptor of the present invention are long-life devices free from image density fluctuation and image blurring.

### BRIEF DESCRIPTION OF DRAWINGS

FIG. 1 is a schematic view showing the substantial part configuration of one embodiment of the image formation device of the present invention.

FIG. 2 shows an X-ray diffraction spectrum of oxytitanium phthalocyanine used in Examples.

### DESCRIPTION OF EMBODIMENTS

Best embodiments for carrying out the present invention are described in detail hereinunder. However, the present invention is not restricted to the following embodiments, and within the range not overstepping the scope and the spirit thereof, the present invention may be modified and carried out in any desired manner.

Here in the present description, “% by mass” and “% by weight”, “ppm by mass” and “ppm by weight”, and “part by mass” and “part by weigh” each have the same meanings.

### [Electrophotographic Photoreceptor]

The electrophotographic photoreceptor of the present invention is described in detail hereinunder.

### <Conductive Support>

As the conductive support for use in the photoreceptor, for example, mainly used are metal materials of aluminium, aluminium alloys, stainless steel, copper, nickel, etc.; resin materials given conductivity by a conductive powder of metal, carbon tin oxide or the like added thereto; and resins, glass, paper and the like of which the surface is given a conductive material of aluminium, nickel, ITO (indium oxide tin oxide) or the like through deposition or coating thereon. Regarding the shape of the support, usable here are drums, sheets, belts, etc. Also usable herein is a conductive support of a metal material coated with a conductive material having a suitable resistance value for controlling the conductivity and the surface nature of the support or for covering the defects thereof.

In a case where a metal material such as an aluminium alloy or the like is used as the conductive support, the support may be coated with a coating film through anodic oxidation thereon before use. In the case where the coating film is formed through anodic oxidation, it is desirable that the coating film is processed for sealing treatment according to a known method.

For example, the coating film may be formed through anodic oxidation in an acid bath of chromic acid, sulfuric acid, oxalic acid, boric acid, sulfamic acid or the like. Preferred is anodic oxidation in sulfuric acid as providing a good result. In the case of anodic oxidation in sulfuric acid, it is desirable that the sulfuric acid concentration is within a range of from 100 to 300 g/1, the dissolved aluminium concentration is from 2 to 15 g/1, the liquid temperature is from 15 to 30° C., the electrolysis voltage is from 10 to 20 V, and the current density is from 0.5 to 2 A/dm². However, the present invention is not limited to these conditions.

The thus-formed anodic oxide film is preferably processed for sealing treatment. The sealing treatment may be carried out according to an ordinary method. For example, preferred is low-temperature sealing treatment of dipping in an aqueous solution containing nickel fluoride as the main ingredient, or a high-temperature sealing treatment of dipping in an aqueous solution containing nickel sulfate as the main ingredient.

The concentration of the aqueous nickel fluoride solution for use in the low-temperature sealing treatment may be selected suitably, but is preferably within a range of from 3 to 6 g/l as providing a better result. For smoothly carrying out the sealing treatment, it is desirable that the treatment temperature is from 25 to 40° C., preferably 30 to 35° C., and the pH of the aqueous nickel fluoride solution is from 4.5 to 6.5, preferably from 5.5 to 6.0. As the pH regulator, usable here is any of oxalic acid, boric acid, formic acid, acetic acid, sodium hydroxide, sodium acetate, aqueous ammonia, etc. The treatment time is preferably within a range of from 1 to 3 minutes per the coating film thickness, 1 μm. For further improving the physical properties of the coating film, cobalt fluoride, cobalt acetate, nickel sulfate, surfactant or the like may be added to the aqueous nickel fluoride solution. Next, the coating film is washed with water and dried to finish the low-temperature sealing treatment.

As the sealing agent for the high-temperature sealing treatment, usable is an aqueous solution of a metal salt such as nickel acetate, cobalt acetate, lead acetate, nickel-cobalt acetate, barium nitrate, etc. Especially preferred is use of nickel acetate. In the case of using an aqueous solution of nickel acetate, the concentration is preferably within a range of from 5 to 20 g/l. The treatment temperature may be from 80 to 100° C., preferably from 90 to 98° C. The pH of the aqueous nickel acetate solution for the treatment is preferably within a range of from 5.0 to 6.0. Here, as the pH regulator, usable is aqueous ammonia, sodium acetate or the like. The treatment time is preferably 10 minutes or more, more preferably 20 minutes or more. Also in this case, sodium acetate, an organic carboxylic acid, an anionic or nonionic surfactant or the like may be added to the aqueous nickel acetate solution for improving the physical properties of the coating film.

Next, the coating film is washed with water and dried to finish the high-temperature sealing treatment. For the case of a larger mean thickness of the coating film, needed are stricter sealing conditions of using a high-concentration sealing liquid for high-temperature and long-term treatment. Accordingly, the case worsens the productivity and in addition, the surface of the coating film would have some surface defects of staining, discoloration or powering. From this viewpoint, the mean thickness of the anodic oxide film to be formed is generally 20 μm or less, preferably 7 μm or less.

The surface of the support may be smooth or may be roughened according to any specific cutting method or by any polishing treatment. If desired, particles having a suitable particle size may be mixed in the material to constitute the support to make the surface of the support roughened. For cost reduction, a drawn tube may be used directly as it is, without being further machined. Especially in a case of using an un-machined aluminium substrate prepared through drawing, impact working, ironing or the like, it is desirable that the surface thereof is treated for removing the dirty substances and other substances such as impurities or the like existing on the surface and also for removing some small scratches also existing thereon to give a uniform and clean substrate.

### <Undercoat Layer>

An undercoat layer may be provided between the conductive support and the photosensitive layer to be mentioned below, for improving the adhesiveness and the blocking resistance therebetween. As the undercoat layer, usable here are resins, as well as those prepared by dispersing particles of a metal oxide or the like in resins, etc.

Examples of the metal oxide particles for use in the undercoat layer include particles of a metal oxide containing one type of a metal element such as titanium oxide, aluminium oxide, silicon oxide, zirconium oxide, zinc oxide, iron oxide, etc.; and particles of a metal oxide containing multiple types of metal elements such as calcium titanate, strontium titanate, barium titanate, etc. One type alone of particles or multiple types of particles may be used either singly or as combined. Of these metal particles, preferred are particles of titanium oxide and aluminium oxide, and more preferred are those of titanium oxide. Titanium oxide particles for use herein may be surface-treated with an inorganic substance such as tin oxide, aluminium oxide, antimony oxide, zirconium oxide, silicon oxide, etc., or with an organic substance such as stearic acid, polyol silicone, etc. Regarding the crystal form of the titanium oxide particles, usable here are any of rutile-type, anatase-type, brookite-type or amorphous particles. Also employable are particles of different crystal forms as combined.

Regarding the particle size thereof, the metal oxide particles to be used here may have any different particle size, but from the viewpoint of the properties thereof and of the stability of the liquid containing them, the mean primary particle size of the particles is preferably from 10 nm to 100 nm, more preferably from 10 nm to 50 nm. The mean primary particle size may be determined on TEM photographic pictures, etc.

Preferably, the undercoat layer is formed of a dispersion of the metal oxide particles in a binder resin. As the binder resin for the undercoat layer, usable is any known binder resin including epoxy resin, polyethylene resin, polypropylene resin, acrylic resin, methacrylic resin, polyamide resin, vinyl chloride resin, vinyl acetate resin, phenolic resin, polycarbonate resin, polyurethane resin, polyimide resin, vinylidene chloride resin, polyvinyl acetal resin, vinyl chloride-vinyl acetate copolymer, polyvinyl alcohol resin, polyurethane resin, polyacrylic acid resin, polyacrylamide resin, polyvinylpyrrolidone resin, polyvinylpyridine resin, water-soluble polyester resin, cellulose ester resin such as nitrocellulose or the like, cellulose ether resin, casein, gelatin, polyglutamic acid, starch, starch acetate, aminostarch, organozirconium compound such as zirconium chelate compound, zirconium alkoxide compound or the like, organotitanium compound such as titanyl chelate compound, titanyl alkoxide compound or the like, slime coupling agent, etc. One alone of these may be used or any one or more of these may be cured with a curing agent for use herein. Above all, preferred are alcohol-soluble copolyamide and modified polyamide, as exhibiting good dispersibility and coatability.

The ratio of the inorganic particles to the binder resin to be used in the undercoat layer may be selected in any manner, but from the viewpoint of the stability and the coatability of the dispersion, it is desirable that the ratio falls generally in a range of from 10% by mass to 500% by mass relative to the binder resin.

The thickness of the undercoat layer may be any desired one not significantly detracting from the advantageous effects of the present invention, but from the viewpoint of improving the electric characteristics, the resistance to strong photoexposure, the image characteristics and the repeatable characteristics of the electrophotographic photoreceptor and improving the coatability with the layer in producing the photoreceptor, the thickness is generally 0.01 μm or more, preferably 0.1 μm or more, and is generally 30 μm or less, preferably 20 μm or less. A known antioxidant or the like may be added to the undercoat layer. In addition, for the purpose of preventing image defects, pigment particles, resin particles or the like may be added to the undercoat layer.

### <Photosensitive Layer>

The photosensitive layer is formed on the above-mentioned conductive support (but on the undercoat layer, if provided). The photosensitive layer is a layer containing the charge-transporting substance defined in the present invention, and the form of the layer is grouped into a single-layer structure in which both a charge-generating substance and a charge-transporting substance (including the charge-transporting substance defined in the present invention) exists in one and the same layer and in which the two are dispersed in a binder resin (hereinafter appropriately referred to as “single-layer photosensitive layer”), and a laminate-structured, functional separation-type photosensitive layer that comprises two or more layers including a charge generation layer where a charge-generating substance is dispersed in a binder resin and a charge transport layer where a charge-transporting substance (including the charge-transporting substance defined in the present invention) is dispersed in a binder resin (hereinafter the layer of the type is appropriately referred to as “laminate-type photosensitive layer”). The present invention applies to any of these structures.

The laminate-type photosensitive layer is further grouped into a sequential laminate-type photosensitive layer in which a charge generation layer and a charge transport layer are laminated in that order from the side of the conductive support, and an inverse laminate-type photosensitive layer in which, contrary to the above, a charge transport layer and a charge generation layer are laminated in that order from the side of the conductive support. The present invention applied to any of these types of layers, but preferred is the sequential laminate-type photosensitive layer capable of exhibiting especially well-balanced photoconductivity.

### <Amine Compound>

In the present invention, the photosensitive layer contains a compound represented by the formula (1).

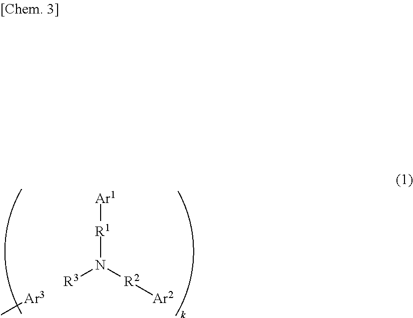

(In the formula (1), R¹ to R³ each independently represent an alkylene group having 3 or less carbon atoms and optionally having a substituent, Ar¹ and Ar² each independently represent a hydrogen atom, an alkyl group optionally having a substituent, or an aryl group optionally having a substituent, Ar³ represents an aryl group optionally having a substituent, or an arylene group optionally having a substituent. k indicates an integer of 1 or 2.)

R¹ to R³ each independently represent an alkylene group having 3 or less carbon atoms and optionally having a substituent. In view of the electric characteristics of the compound, the carbon number of these groups is preferably 2 or less, more preferably 1. The substituent that R¹ to R³ may have includes an alkyl group, an aryl group, an alkoxy group, a halogen atom, etc. Concretely, the alkyl group includes a linear alkyl group such as a methyl group, an ethyl group, an n-propyl group, an n-butyl group, etc.; a branched alkyl group such as an isopropyl group, an ethylhexyl group, etc., a cyclic alkyl group such as a cyclohexyl group, etc. The aryl group includes a phenyl group, a naphthyl group or the like optionally having a substituent. The alkoxy group includes a linear alkoxy group such as a methoxy group, an ethoxy group, an n-propoxy group, an n-butoxy group, etc.; a branched alkoxy group such as an isopropoxy group, an ethylhexyl group, etc.; a cyclic alkoxy group such as a cyclohexyloxy group, etc.; and an alkoxy group having a fluorine atom, such as a trifluoromethoxy group, a pentafluoroethoxy group, a 1,1,1-trifluoroethoxy group, etc. The halogen atom includes a fluorine atom, a chlorine atom, a bromine atom, etc.

In consideration of the influence of the groups on the residual potential of the layer, it is desirable that R¹ to R³ do not have a substituent.

Ar¹ and Ar² each independently represent a hydrogen atom, an alkyl group optionally having a substituent, or an aryl group optionally having a substituent. The total carbon number of the alkyl group optionally having a substituent is generally 20 or less, preferably 15 or less, more preferably 10 or less. The total carbon number of the aryl group optionally having a substituent is generally 30 or less, preferably 20 or less, more preferably 15 or less. The substituent that Ar¹ and Ar² may optionally have includes those mentioned hereinabove as the substituent that R¹ to R³ may have.

In consideration of the relationship between the ionization potential of the compound and that of the charge-transporting substance in the layer, it is desirable that Ar¹ and Ar² do not have a substituent.

Ar³ represents an aryl group optionally having a substituent. The aryl group optionally having a substituent is as described above for Ar¹ and Ar². In consideration of the relationship between the ionization potential of the compound and that of the charge-transporting substance, it is desirable that Ar³ does not have a substituent. When k is 2, Ar³ is an arylene group optionally having a substituent, which may bond directly to the other Ar³ via a single bond, or may bond to the other Ar³ via a substituent.

k indicates an integer of 1 or 2. From the viewpoint of production of the compound, k is preferably 1.

The molecular weight of the amine compound in the present invention is, from the viewpoint of the ozone resistance of the compound, preferably 100 or more as the lower limit, more preferably 200 or more. From the viewpoint of the electric characteristics of the compound, the upper limit may be 900 or less, preferably 700 or less, more preferably 600 or less.

The content of the amine compound in the layer in the present invention is generally 0.01 parts by mass or more, preferably 0.5 parts by mass or more, more preferably 1 part by mass or more relative to 100 parts by mass of the binder resin in the layer. The charge-transporting substance in the present invention has the advantage that even a small amount of the substance can exhibit the effect thereof, and for securing a low residual potential, the content of the compound is preferably 10 parts by mass or less, more preferably 5 parts by mass or less, even more preferably 2 parts by mass or less.

The content is generally 0.03 parts by mass or more, preferably 0.1 parts by mass or more, more preferably 0.2 parts by mass or more, relative to 100 parts of the total amount of the charge-transporting substance. The charge-transporting substance in the present invention has the advantage that even a small amount of the substance can exhibit the effect thereof, and in consideration of the residual potential and the abrasion resistance of the layer, the content is preferably 25 parts by mass or less, more preferably 10 parts by mass or less, even more preferably 5 parts by mass or less.

Preferred examples of the compound are shown below.

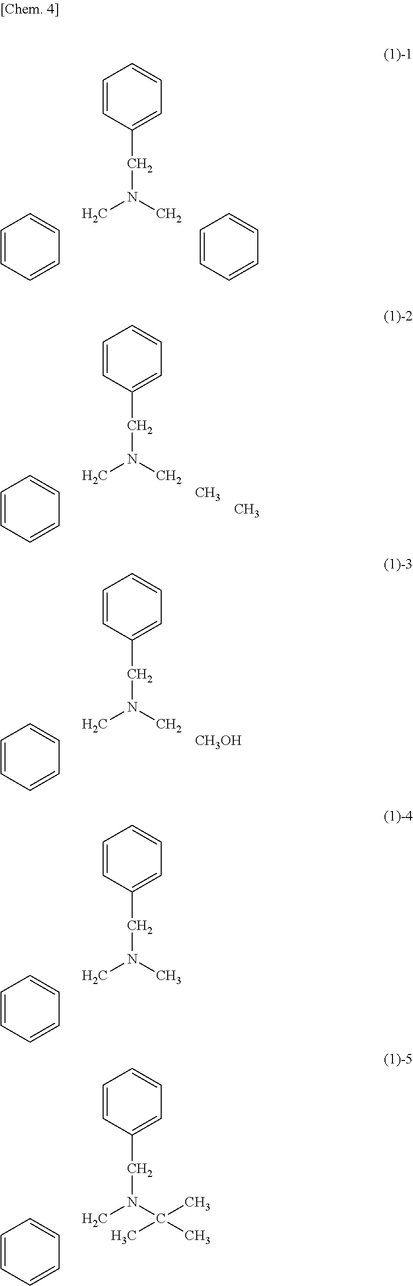

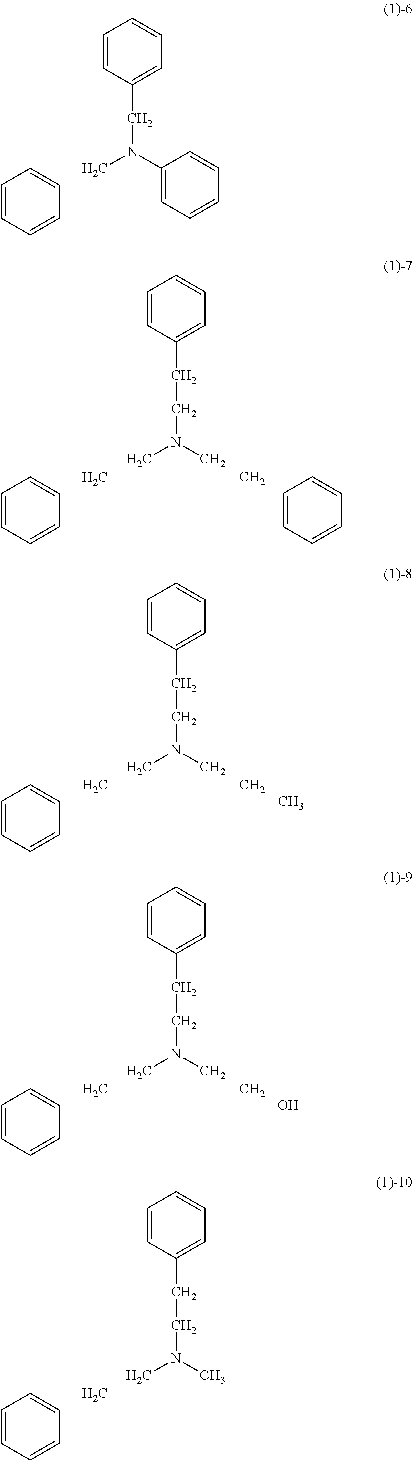

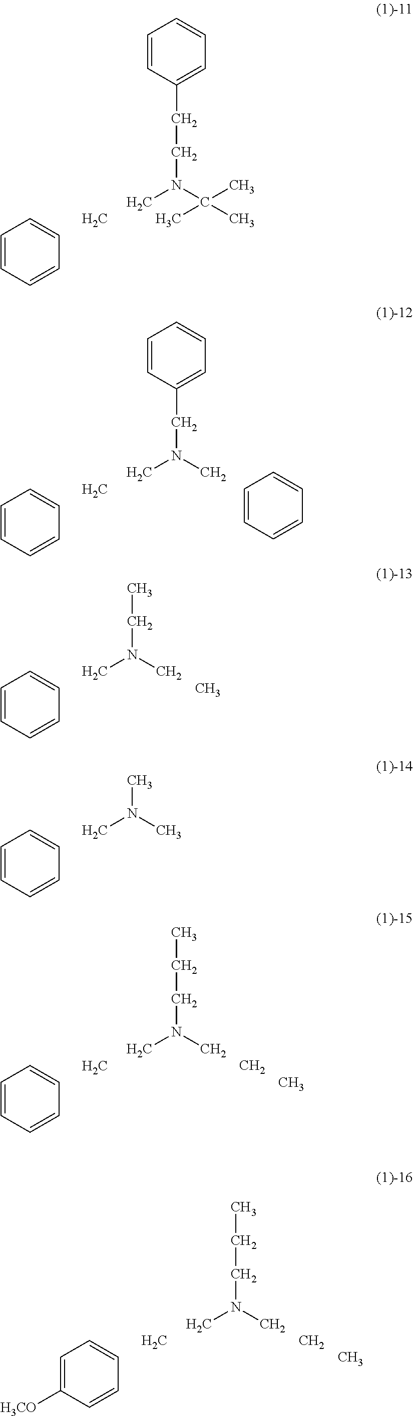

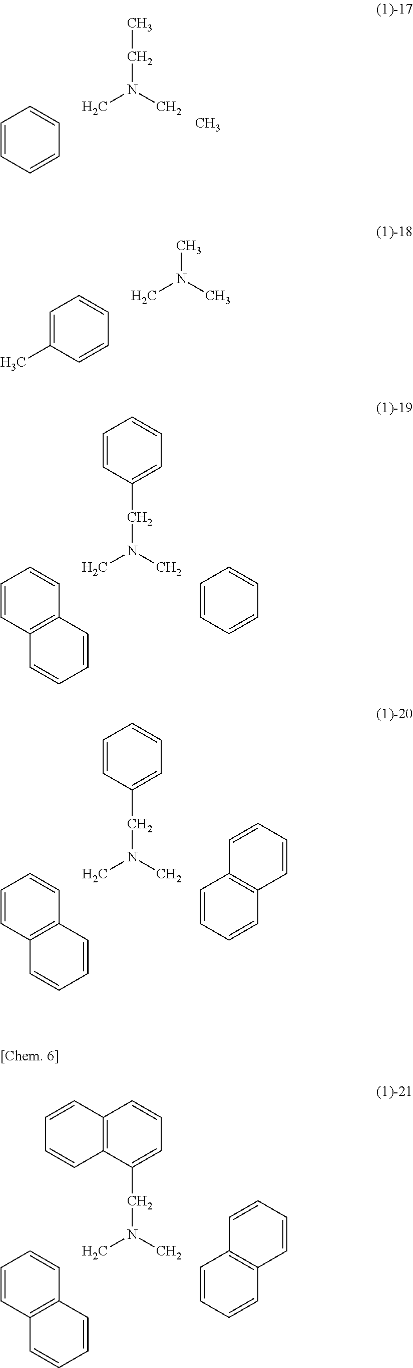

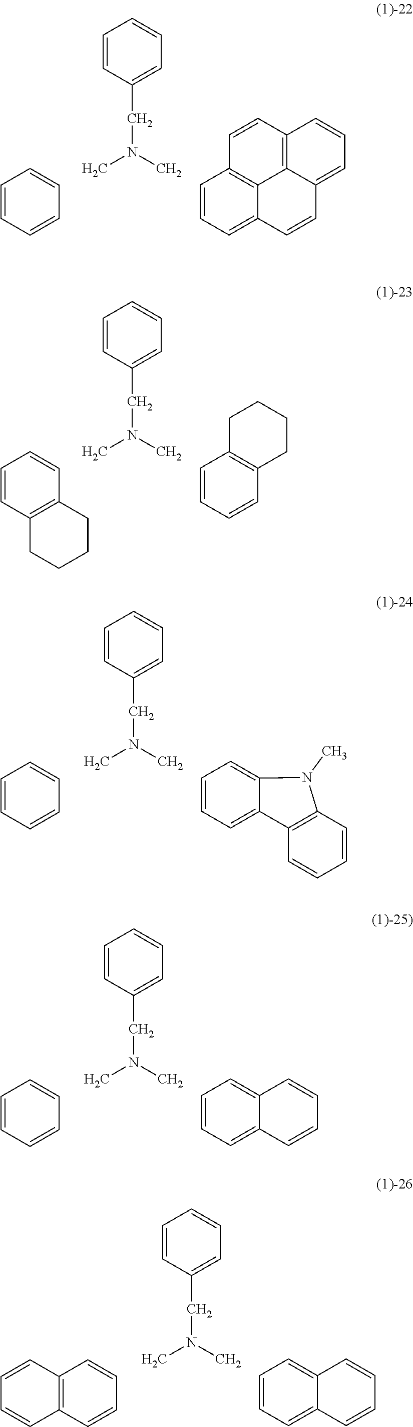

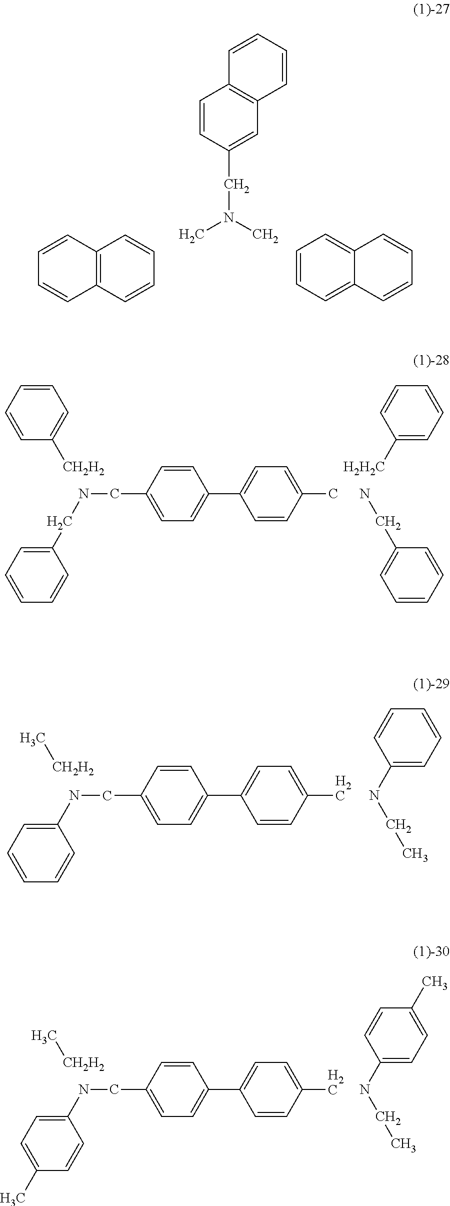

Preferably, these amine compounds have a suitable degree of basicity and a larger oxidation potential or ionization potential than the oxidation potential or ionization potential of the charge-transporting substance, in order that the compound could have a low residual potential and could stabilize the electric characteristics of the layer. The amino group (—NH—) form a charge trap in the photosensitive layer and noticeably have some negative influence on the electric characteristics. In addition, in order that the compound does not evaporate away in the drying process in production of the photoreceptor, it is desirable that the boiling point of the compound is 100° C. or higher. Preferred are amine compounds having at least one aralkyl group such as benzyl group, like the exemplified compounds. The amine compound of the type has suitable basicity and oxidation potential, and therefore a benzyl position or the like of the amine compound could be selectively oxidized earlier than the charge-transporting substance in the present invention, and consequently, it is considered that the compound is excellent in the function of trapping ozone, NOx or the like gas. Above all, preferred are those having two or more aralkyl groups, and more preferred are those having three such groups. In case where the ionization potential of the compound is sufficiently higher than that of the charge-transporting substance, then the compound would be readily oxidized, and therefore, the lower limit of the ionization potential of the compound is generally 6.00 eV or more, preferably 6.25 eV or more, more preferably 6.40 eV or more. The upper limit is generally 7.00 eV or less and preferably 6.80 eV or less, from the viewpoint of the electric characteristics of the compound. In case where the electronic affinity of the compound is sufficiently lower than that of the charge-transporting substance, the compound would be readily oxidized, and therefore, the upper limit thereof is generally 2.00 eV or less, preferably 1.80 eV or less, more preferably 1.50 eV or less. The lower limit is, from the viewpoint of the electric characteristics, generally 0.50 eV or more, preferably 1.00 eV or more, more preferably 1.20 eV or more.

### <Functional Separation-Type Photosensitive Layer>

### <Charge Generation Layer>

The charge generation layer in the laminate-structured photosensitive layer (functional separation-type photosensitive layer) contains a charge-generating substance, and generally contains a binder resin and any other optional component. The charge generation layer of the type may be formed, for example, by dissolving or dispersing fine particles of a charge-generating substance and a binder resin in a solvent or a dispersion medium to prepare a coating liquid, and applying it onto a conductive support in a case of a sequential laminate-type photosensitive layer (or in a case of providing an undercoat layer, onto the undercoat layer), or onto the charge transport layer in a case of an inverse laminate-type photosensitive layer, and thereafter drying it.

Concretely, the charge generation layer in the functional separation-type photosensitizer may be formed by dispersing a binder resin and a charge-generating substance in an organic solvent to prepare a coating liquid and applying the liquid onto a conductive support (but in a case of providing an undercoat layer, onto the undercoat layer).

In the charge generation layer in the functional separation-type photoreceptor, the blend ratio (by mass) of the charge-generating substance to the binder resin is from 10 to 1000 parts by mass, preferably from 30 to 500 parts by mass relative to 100 parts by mass of the binder resin. The thickness of the layer is generally from 0.1 μm to 10 μm, preferably from 0.15 μm to 0.6 μm. When the ratio of the charge-generating substance is too high, then the stability of the coating liquid may worsen owing to aggregation of the charge-generating substance. On the other hand, when the ratio of the charge-generating substance is too low, the sensitivity of the photoreceptor would lower.

### <Binder Resin>

Examples of the binder resin for use in the charge generation layer in the functional separation-type photoreceptor include polyvinyl butyral resins, polyvinyl formal resins, polyvinyl acetal resins such as partially-acetalized polyvinyl butyral resin where a part of butyral is modified with formal, acetal or the like, polyarylate resins, polycarbonate resins, polyester resins, modified ether-type polyester resins, phenoxy resins, polyvinyl chloride resins, polyvinylidene chloride resins, polyvinyl acetate resins, polystyrene resins, acrylic resins, methacrylic resins, polyacrylamide resins, polyimide resins, polyvinylpyridine resins, cellulosic resins, polyurethane resins, epoxy resins, silicone resins, polyvinyl alcohol resins, polyvinyl pyrrolidone resins, casein, vinyl chloride-vinyl acetate-based copolymers such as vinyl chloride-vinyl acetate copolymers, hydroxy-modified vinyl chloride-vinyl acetate copolymers, carboxy-modified vinyl chloride-vinyl acetate copolymers, vinyl chloride-vinyl acetate-maleic anhydride copolymers, etc., styrene-butadiene copolymers, vinylidene chloride-acrylonitrile copolymers, insulating resins such as styrene-alkyd resins, silicone-alkyl resins, phenol-formaldehyde resins, etc., organic photoconductive polymers such as poly-N-vinylcarbazole, polyvinylanthracene, polyvinylperylene, etc. The binder resin may be selected from the above, but is not limited to these polymers. One alone or two or more different types of these binder resins may be used here either singly or as combined.

As the solvent and the dispersion medium in which the binder resin is dissolved in preparing the coating liquid, for example, there are mentioned saturated aliphatic solvents such as pentane, hexane, octane, nonane, etc.; aromatic solvents such as toluene, xylene, anisole, etc.; halogenoaromatic solvents such as chlorobenzene, dichlorobenzene, chloronaphthalene, etc.; amide solvents such as dimethylformamide, N-methyl-2-pyrrolidone, etc.; alcohol solvents such as methanol, ethanol, isopropanol, n-butanol, benzyl alcohol, etc.; aliphatic polyalcohols such as glycerin, polyethylene glycol, etc.; linear and cyclic ketone solvents such as acetone, cyclohexanone, methyl ethyl ketone, etc.; ester solvents such as methyl formate, ethyl acetate, n-butyl acetate, etc.; halogenohydrocarbon solvents such as methylene chloride, chloroform, 1,2-dichloroethane, etc.; linear and cyclic ether solvents such as diethyl ether, dimethoxyethane, tetrahydrofuran, 1,4-dioxane, methyl cellosolve, ethyl cellosolve, etc.; aprotic polar solvents such as acetonitrile, dimethyl sulfoxide, sulfolane, hexamethylphosphoric acid triamide, etc.; nitrogen-containing compounds such as n-butylamine, isopropanolamine, diethylamine, triethanolamine, ethylenediamine, triethylenediamine, triethylamine, etc.; mineral oils such as ligroin, etc.; water, etc. Preferred are those not dissolving the undercoat layer. One alone or two or more different types of these may be used here either singly or as combined.

### <Charge-Generating Substance>

One charge-generating substance may be used, or a mixture with some dyes and pigments may also be used here. The charge-generating substance includes inorganic photoconductive materials such as selenium and its alloys, cadmium sulfide, etc.; and organic photoconductive materials such as organic pigments, etc. Preferred are organic photoconductive materials, and above all, especially preferred are organic pigments. The organic pigments include, for example, phthalocyanine pigments, azo pigments, dithioketopyrrolopyrrole pigments, squalene (squarylium) pigments, quinacridone pigments, indigo pigments, perylene pigments, polycyclic quinone pigments, anthanthrone pigments, benzimidazole pigments, etc. Of those, as the dyes and pigments to be used as a mixture thereof, phthalocyanine pigments and azo pigments are especially preferred from the viewpoint of the photosensitivity thereof. In a case where an organic pigment is used as the charge-generating substance, in general, fine particles of the organic pigment are bound with a binder resin to form a dispersion phase thereof for use herein.

In a case where a phthalocyanine pigment is used as the charge-generating substance, concretely, a metal-free phthalocyanine or a metal-containing phthalocyanine is used. Examples of the metal-containing phthalocyanine include various crystal forms of phthalocyanines coordinated with a metal such as copper, indium, gallium, tin, titanium, zinc, vanadium, silicon, germanium or the like, or with an oxide, a halide, a hydroxide, an alkoxide or the like thereof. Especially preferred are titanyl phthalocyanine (also referred to as oxytitanium phthalocyanine) such as A-type (also referred to as β-type), B-type (also referred to as α-type), D-type (also referred to as Y-type) or the like which are a crystal form having a high sensitivity, vanadyl phthalocyanine, chloroindium phthalocyanine, II-type or the like chlorogallium phthalocyanine, V-type or the like hydroxygallium phthalocyanine, G-type, I-type or the like μ-oxo-gallium phthalocyanine dimer, and II-type or the like μ-oxo-aluminium phthalocyanine dimer.

Of those phthalocyanines, more preferred are A-type (β-type), B-type (α-type), D-type (Y-type) oxytitanium phthalocyanines, II-type chlorogallium phthalocyanine, V-type hydroxygallium phthalocyanine, G-type μ-oxo-gallium phthalocyanine dimer, etc. Of the oxytitanium phthalocyanines, preferred are those showing main clear diffraction peaks at the Bragg angle (2θ±0.2°) of 27.2° in the powdery X-ray diffraction spectrum thereof with CuKα-specific X-ray.

Of the oxytitanium phthalocyanines, also preferred are those showing main clear diffraction peaks at the Bragg angle (2θ±0.2°) of from 9.0° to 9.7° in the powdery X-ray diffraction spectrum thereof with CuKα-specific X-ray. From the viewpoint of the electrophotographic characteristics thereof, preferred are those having main diffraction peaks at 9.6°, 24.1° and 27.2°, or at 9.5°, 9.7°, 24.1° and 27.2°. From the viewpoint of the stability in dispersion thereof, it is desirable that the compounds do not have a peak at around 26.2°. Of the above-mentioned oxytitanium phthalocyanines, more preferred are those having main diffraction peaks at 7.3°, 9.6°, 11.6°, 14.2°, 18.0°, 24.1° and 27.2°, or at 7.3°, 9.5°, 9.7°, 11.6°, 14.2°, 18.0°, 24.2° and 27.2°.

Using a metal-free phthalocyanine compound or a metal-containing phthalocyanine compound as the charge-generating substance provides a photoreceptor having a high sensitivity to a laser light having a relatively long wavelength, for example, to a laser light having a wavelength of around 780 nm or so. Using an azo pigment such as a monoazo, diazo, trisazo or the like pigment provides a photoreceptor having a sufficient sensitivity to white light, to a laser light having a wavelength of around 660 nm or so, or to a laser light having a relatively short wavelength (for example, a laser light having a wavelength falling within a range of from 380 nm to 500 nm).

A single phthalocyanine compound may be used here, or a mixture of two or more such compounds or a mixed liquid thereof may also be used here. Regarding the mixture of phthalocyanine compounds or different crystal forms of the compounds, the individual constituent elements may be mixed layer, or the mixed state may be formed in the process of production or treatment of phthalocyanine compounds, for example, in a process of synthesis, pigment formation or crystallization thereof. As the treatment, there are known acid paste treatment, grinding treatment, solvent treatment, etc. For forming a mixed crystal state, employable is a method of mixing two types of crystals, mechanically grinding them and making them amorphous, and thereafter converting them into those having a specific crystal state through solvent treatment, as described in JP-A 10-48859.

On the other hand, in a case where an azo pigment is used as the charge-generating substance, heretofore-known azo pigments may be used so far as they are sensitive to a light source for optical input, and various types of bisazo pigments and trisazo pigments are preferred. Examples of preferred azo pigments are shown below.

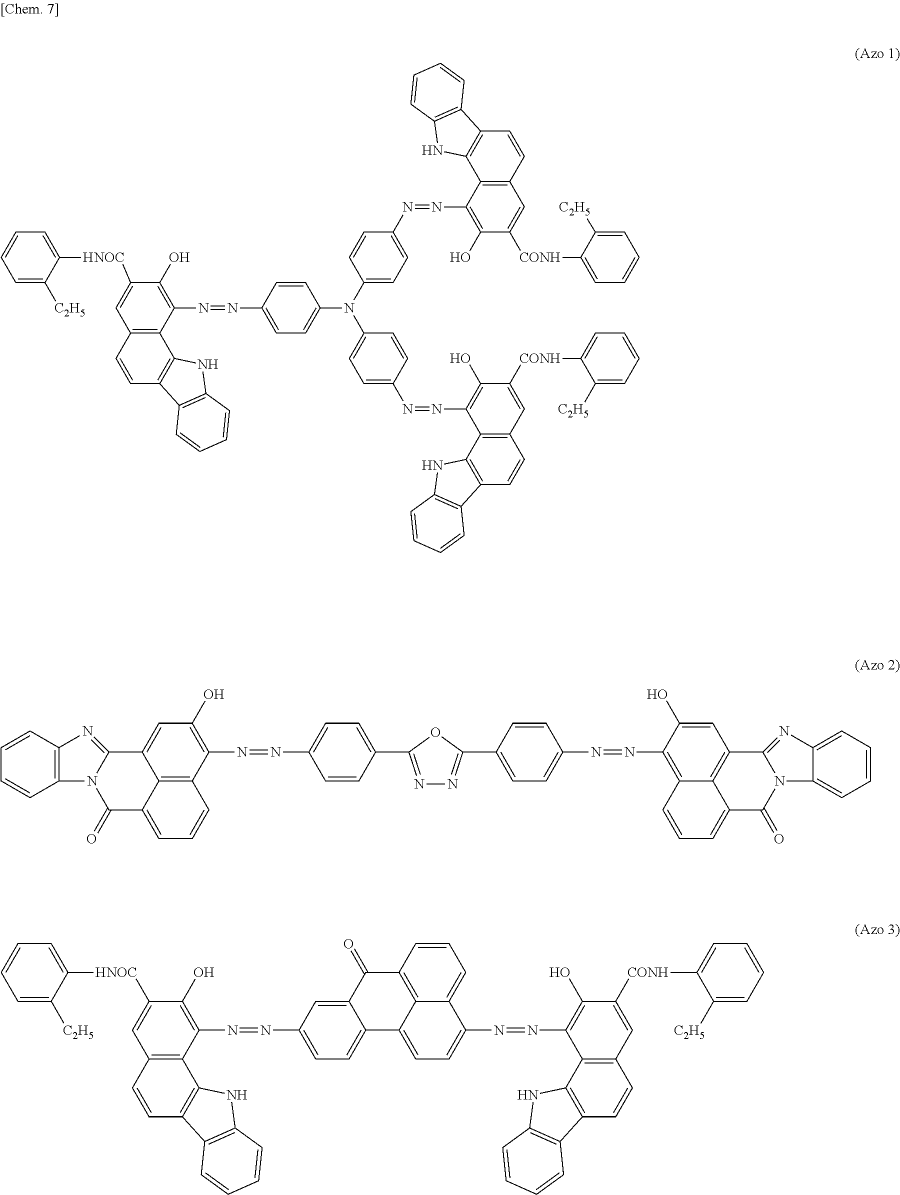

In a case where the organic pigments mentioned above are used as the charge-generating substance, one alone thereof may be used, but two or more different types of the pigments may be used as mixed. In this case, it is desirable that two or more different types of such charge-generating substances having a spectral sensitivity characteristic in a different spectral region of a visible light range or a near-IR range are combined. Above all, preferred is use of a disazo pigment, a trisazo pigment and a phthalocyanine pigment, as combined.

As the method of dispersing the charge-generating substance, employable is any known dispersion method such as a ball mill dispersion method, an attritor dispersion method, a sand mill dispersion method, etc. In the case, it is effective to finely disperse the particles into those having a particle size of 0.5 μm or less, preferably 0.3 μm or less, more preferably 0.15 μM or less.

### <Charge Transport Layer>

In forming the charge transport layer in a functional separation-type photoreceptor that comprises a charge generation layer and a charge transport layer, a binder resin is used for securing the film strength. In the case of the charge transport layer in a functional separation-type photoreceptor, a coating liquid is prepared by dissolving or dispersing charge-transporting substance and a binder resin in a solvent. On the other hand, in a single-layer photoreceptor, a charge-generating substance and a charge-transporting substance and also a binder are dissolved or dispersed in a solvent to prepare a coating liquid. In both cases, the coating liquid is applied and dried thereon to form the layer.

In the case of a laminate-type photoreceptor, the thickness of the charge transport layer is not specifically defined. From the viewpoint of life prolongation and image stability, and further from the viewpoint of high resolution, the thickness if generally 5 μm or more, preferably 10 μm or more, and is, on the other hand, generally 50 μm or less, preferably 45 μm or less, more preferably 30 μm or less.

### <Binder Resin>

A binder resin is used for securing the film strength. The binder resin in the charge transport layer includes, for example, butadiene resins, styrene resins, vinyl acetate resins, vinyl chloride resins, acrylate resins, methacrylate resins, polymers and copolymers of vinyl compounds such s vinyl alcohol resins, ethyl vinyl ethers, etc., polyvinyl butyral resins, polyvinyl formal resins, partially-modified polyvinyl acetals, polycarbonate resins, polyester resins, polyarylate resins, polyamide resins, polyurethane resins, cellulose ester resins, phenoxy resins, silicone resins, silicone-alkyd resins, poly-N-vinylcarbazole resins, etc. Of those, preferred are polycarbonate resins and polyarylate resins. Before use herein, these binder resins may be crosslinked by heat, light or the like using a suitable curing agent. Any one alone or two or more of these binder resins may be used either singly or as combined in any desired manner. The charge-transporting substance in the present invention is especially effective in the case where a polyarylate resin is used. In the case where a polyarylate resin is used, the electric characteristics of the layer would worsen as compared with those in the case where a polycarbonate resin is used, but even in the case where the charge-transporting substance in the present invention is sued, the layer can satisfy both excellent abrasion resistance and excellent electric characteristics.

Specific examples of preferred structures of the binder resins are shown below. These examples are shown only for exemplification, and in the present invention, any known binder resins may be mixed and used not contradictory to the spirit and the effect of the present invention.

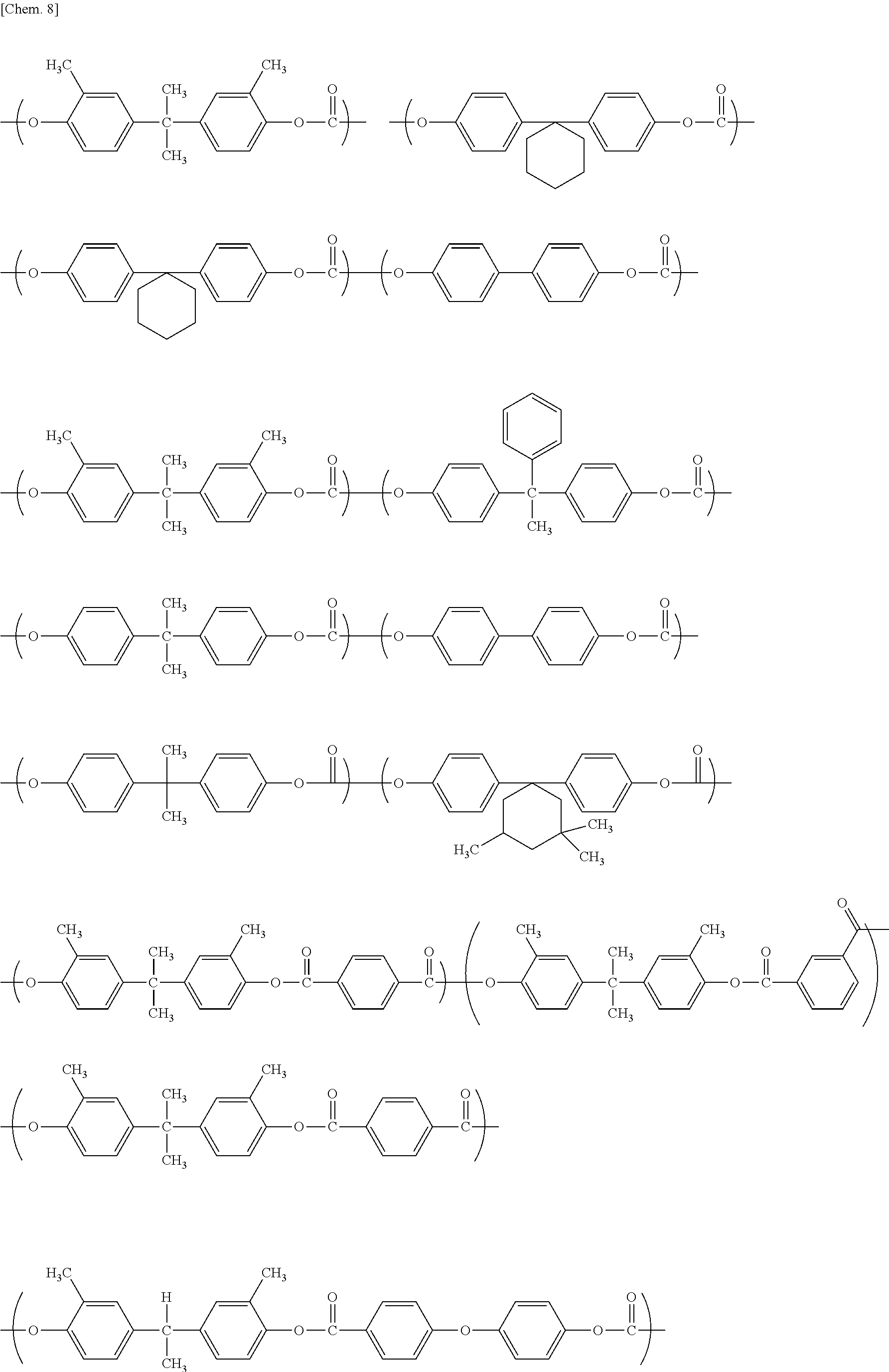

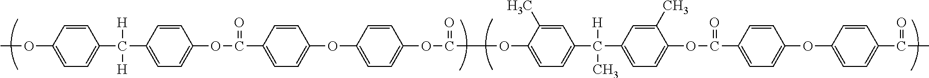

Regarding the proportion of the binder resin to the charge-transporting substance, preferably, the charge-transporting substance is used in an amount of 30 parts by mass or more relative to 100 parts by mass of the binder resin. In particular, from the viewpoint of reducing the residual potential, the amount is preferably 35 parts by mass or more, and further from the viewpoint of the stability and the charge mobility in repeated use, the amount is more preferably 40 parts by mass or more. On the other hand, from the viewpoint of the thermal stability of the photosensitive layer, the charge-transporting substance is used generally in an amount of 100 parts by mass or less. In particular, from the viewpoint of the miscibility of the charge-transporting substance and the binder resin, the amount is preferably 80 parts by mass or less, from the viewpoint of the printing durability of the layer, the amount is more preferably 80 parts by mass or less, and from the viewpoint of the scratch resistance of the layer, the amount is especially preferably 60 parts by mass or less.

### <Charge-Transporting Substance>

In the present invention, the photosensitive layer contains a charge-transporting substance represented by the following formula (2). Preferably, the charge-transporting substance represented by the following formula (2) is contained in the charge transport layer of the photosensitive layer.

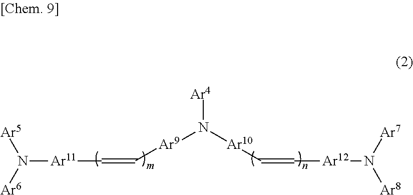

(In the formula (2), Ar⁴ to Ar⁸ each independently represent an aryl group optionally having a substituent, Ar⁹ to Ar¹² each independently represent an arylene group optionally having a substituent, and m and n each independently indicate an integer of from 1 to 3.)

In the above formula (2), Ar⁴ to Ar⁸ each independently represent an aryl group optionally having a substituent. The carbon number of the aryl group is preferably 30 or less, more preferably 20 or less, even more preferably 15 or less, and is generally 6 or more. Concretely, the group includes a phenyl group, a naphthyl group, a biphenyl group, an anthryl group, a phenanthryl group, etc. Above all, preferred is a phenyl group or a naphthyl group in consideration of the characteristics of the electrophotographic photoreceptor. From the viewpoint of the charge transportation capability of the compound, more preferred is a phenyl group or a naphthyl group, and even more preferred is a phenyl group. The substituent that Ar⁴ to Ar⁸ may have includes an alkyl group, an aryl group, an alkoxy group, a halogen atom, etc. Concretely, the alkyl group includes a linear alkyl group such as a methyl group, an ethyl group, an n-propyl group, an n-butyl group, etc.; a branched alkyl group such as an isopropyl group, an ethylhexyl group, etc.; and a cyclic alkyl group such as a cyclohexyl group, etc. The aryl group includes a phenyl group, a naphthyl group and the like optionally having a substituent. The alkoxy group includes a linear alkoxy group such as a methoxy group, an ethoxy group, an n-propoxy group, an n-butoxy group, etc.; a branched alkoxy group such as an isopropoxy group, an ethylhexyloxy group, etc.; a cyclic alkoxy group such as a cyclohexyloxy group, etc.; and an alkoxy group having a fluorine atom, such as a trifluoromethoxy group, a pentafluoroethoxy group, a 1,1,1-trifluoroethoxy group, etc. The halogen atom includes a fluorine atom, a chlorine atom, a bromine atom, etc. Of those, from the viewpoint of the popularity of the starting materials in producing the compound, preferred are an alkyl group having from 1 to 20 carbon atoms, and an alkoxy group having from 1 to 20 carbon atoms. From the viewpoint of the handleability of the materials in the compound production, more preferred are an alkyl group having from 1 to 12 carbon atoms, and an alkoxy group having from 1 to 12 carbon atoms. From the viewpoint of the optical attenuation characteristics of the electrophotographic photoreceptor, more preferred are an alkyl group having from 1 to 6 carbon atoms, and an alkoxy group having from 1 to 6 carbon atoms. The substituent for Ar⁴ is, from the viewpoint of the solubility of the compound, especially preferably an alkoxy group having from 1 to 6 carbon atoms or an alkyl group having from 5 to 12 carbon atoms. In a case where Ar⁴ to Ar⁸ each are a phenyl group, preferably from the viewpoint of the charge transportation capability of the compound, the group has a substituent. The number of the substituents for the group may be from 1 to 5, but from the viewpoint of the popularity of the starting materials in the compound production, the number is preferably from 1 to 3, and from the viewpoint of the characteristics of the electrophotographic photoreceptor, the number is more preferably 1 or 2. In a case where Ar⁴ to Ar⁸ each are a naphthyl group, the number of the substituents for the group is preferably 2 or less from the viewpoint of the popularity of the starting material in the compound production, but more preferably the group does not have a substituent. Even more preferably, the number of the substituent is 1, or the group does not have a substituent. Preferably, Ar⁴ to Ar⁸ each have at least one substituent at the ortho-position or the para-position relative to the nitrogen atom of the compound, more preferably at the para-position thereto.

In the above formula (2), Ar⁹ to Ar¹² each independently represent an arylene group optionally having a substituent. Concretely, examples of the group include a phenylene group, a biphenylene group, a naphthylene group, an anthrylene group and a phenanthrylene group. Of those, in consideration of the characteristics of the electrophotographic photoreceptor, preferred are a phenylene group and a naphthylene group, and more preferred is a phenylene group. The substituent that Ar⁹ to Ar¹² may have includes an alkyl group, an aryl group, an alkoxy group, a halogen atom, etc. Concretely, the alkyl group includes a linear alkyl group such as a methyl group, an ethyl group, an n-propyl group, an n-butyl group, etc.; a branched alkyl group such as an isopropyl group, an ethylhexyl group, etc.; and a cyclic alkyl group such as a cyclohexyl group, etc. The aryl group includes a phenyl group, a naphthyl group and the like optionally having a substituent. The alkoxy group includes a linear alkoxy group such as a methoxy group, an ethoxy group, an n-propoxy group, an n-butoxy group, etc.; a branched alkoxy group such as an isopropoxy group, an ethylhexyloxy group, etc.; a cyclic alkoxy group such as a cyclohexyloxy group, etc.; and an alkoxy group having a fluorine atom, such as a trifluoromethoxy group, a pentafluoroethoxy group, a 1,1,1-trifluoroethoxy group, etc. The halogen atom includes a fluorine atom, a chlorine atom, a bromine atom, etc. Of those, from the viewpoint of the popularity of the starting materials in producing the compound, preferred are an alkyl group having from 1 to 6 carbon atoms, and an alkoxy group having from 1 to 6 carbon atoms. From the viewpoint of the handleability of the materials in the compound production, more preferred are an alkyl group having from 1 to 4 carbon atoms, and an alkoxy group having from 1 to 4 carbon atoms. From the viewpoint of the optical attenuation characteristics of the electrophotographic photoreceptor, more preferred are a methyl group, an ethyl group, a methoxy group and an ethoxy group.

When any of Ar⁹ to Ar¹² has a substituent, the molecular structure of the compound would be twisted to expand the intramolecular n-adjoint extension whereby the electron transportation capability of the compound would be lowered. For these reasons, it is desirable that Ar⁹ to Ar¹² do not have a substituent, and from the viewpoint of the characteristics of the electrophotographic photoreceptor, more preferred are a 1,3-phenylene group, a 1,4-phenylene group, a 1,4-naphthylene group, a 2,6-naphthylene group and a 2,8-naphthylene group, and even more preferred is a 1,4-phenylene group.

m and n each independently indicate an integer of from 1 to 3. When m and n are larger, the solubility of the compound in a coating solvent would lower, and therefore the values are preferably 2 or less. From the viewpoint of the charge transportation capability of the charge-transporting substance, more preferred is 1. In a case where m and n are both 1, the group is an ethenyl group and the compound includes geometric isomers. From the viewpoint of the characteristics of the electrophotographic photoreceptor, preferred is a trans-form structure. In a case where m and n are 2, the group is a butadynyl group and the compound also includes geometric isomers. From the viewpoint of the storage stability of the coating liquid, the compound is preferably a mixture of two or more geometric isomers thereof.

The electrophotographic photoreceptor of the present invention may contain a compound represented by the formula (2) as a single component in the photosensitive layer, or may contain a mixture of compounds of the formula (2) therein.

Structures of preferred charge-transporting substances for the present invention are shown below. The following structures are ones for more concretely exemplifying the present invention, and therefore, the present invention is not restricted to the following structures, not overstepping the concept thereof. In the following structures, Et means an ethyl group, Me means a methyl group and nBu means an n-butyl group (the same shall apply hereinunder).

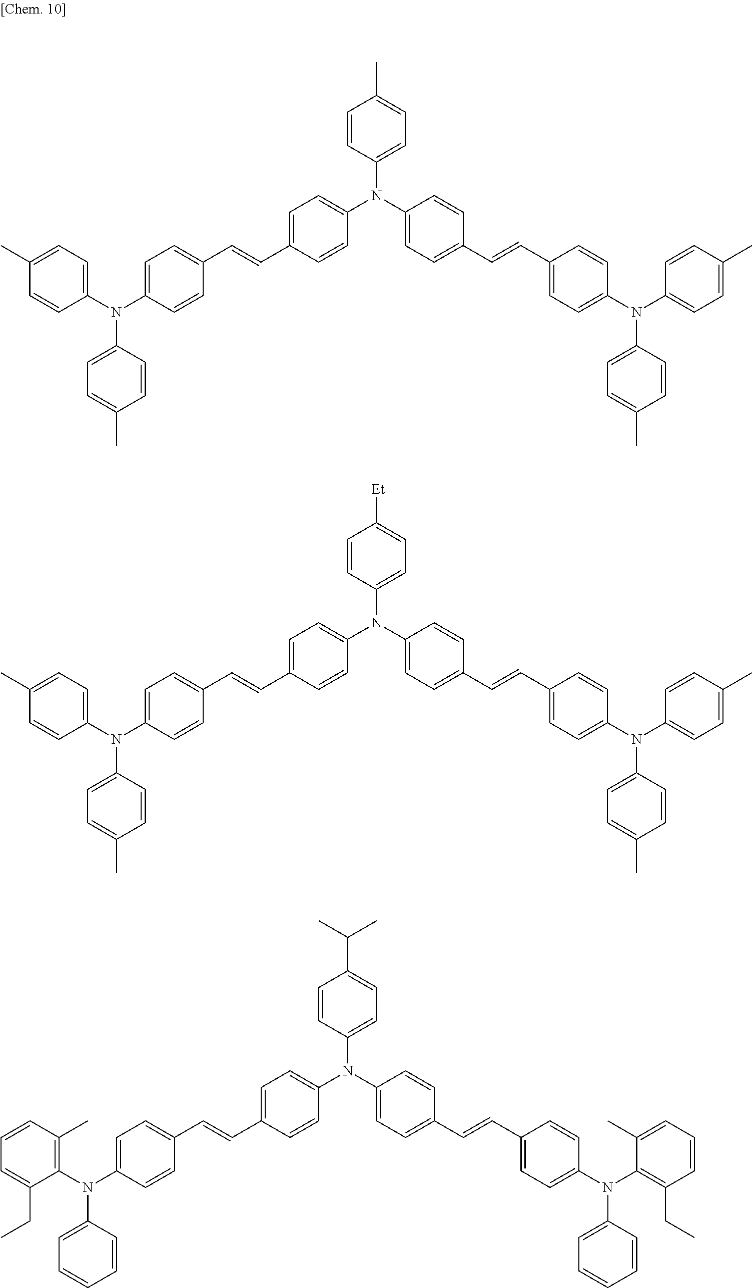

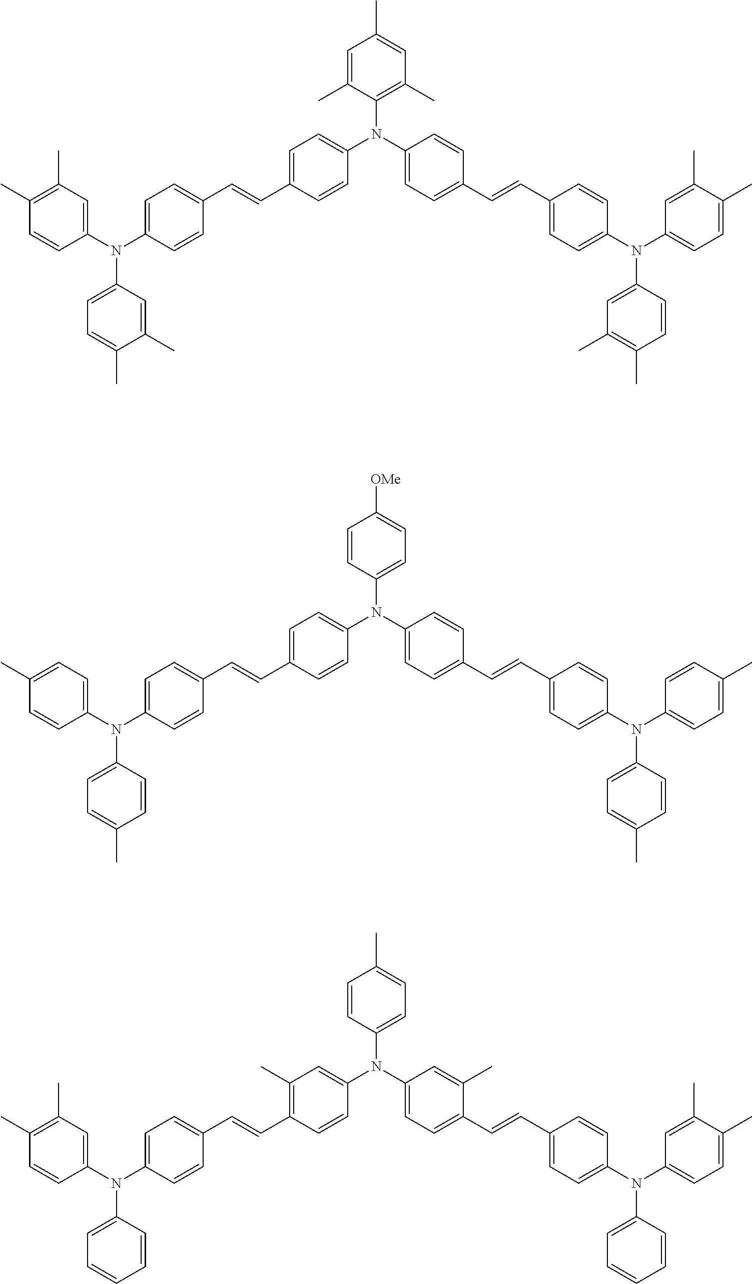

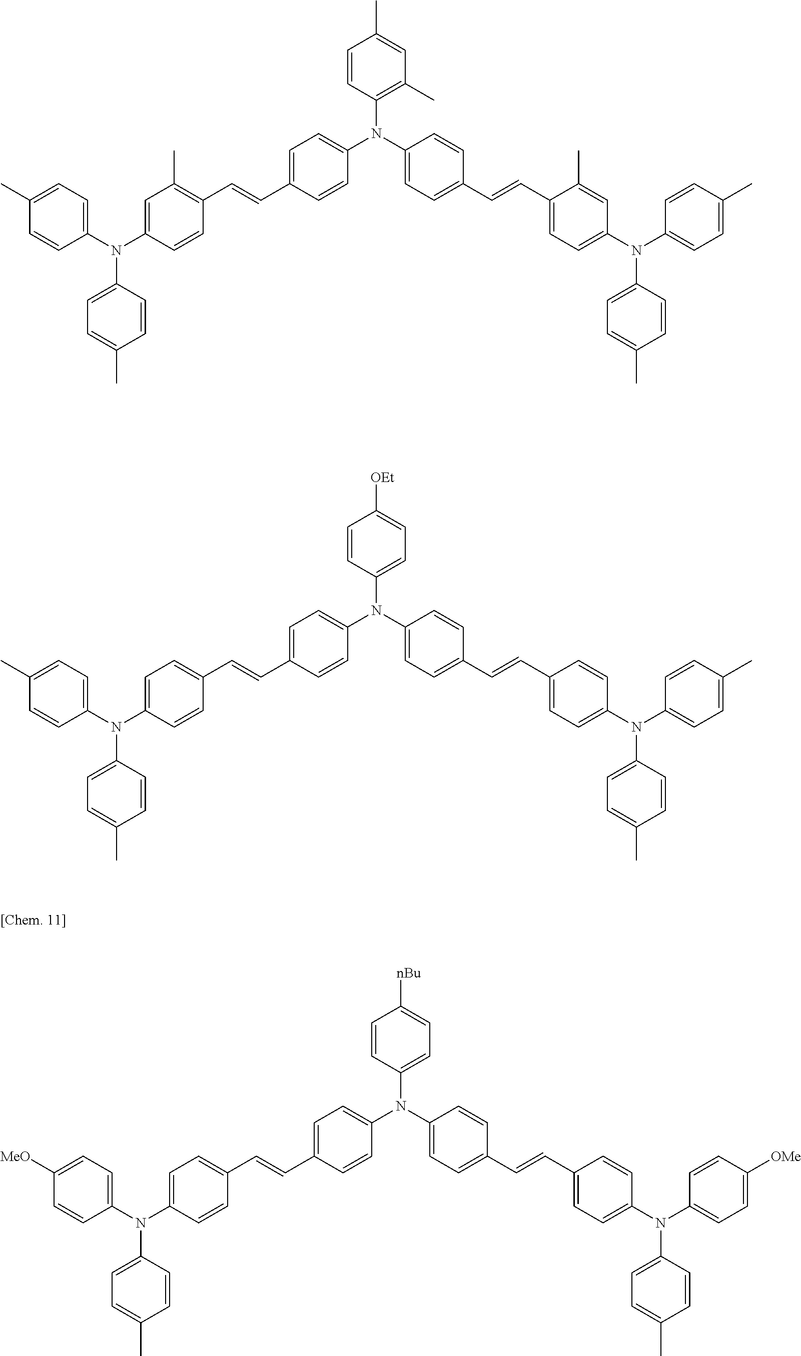

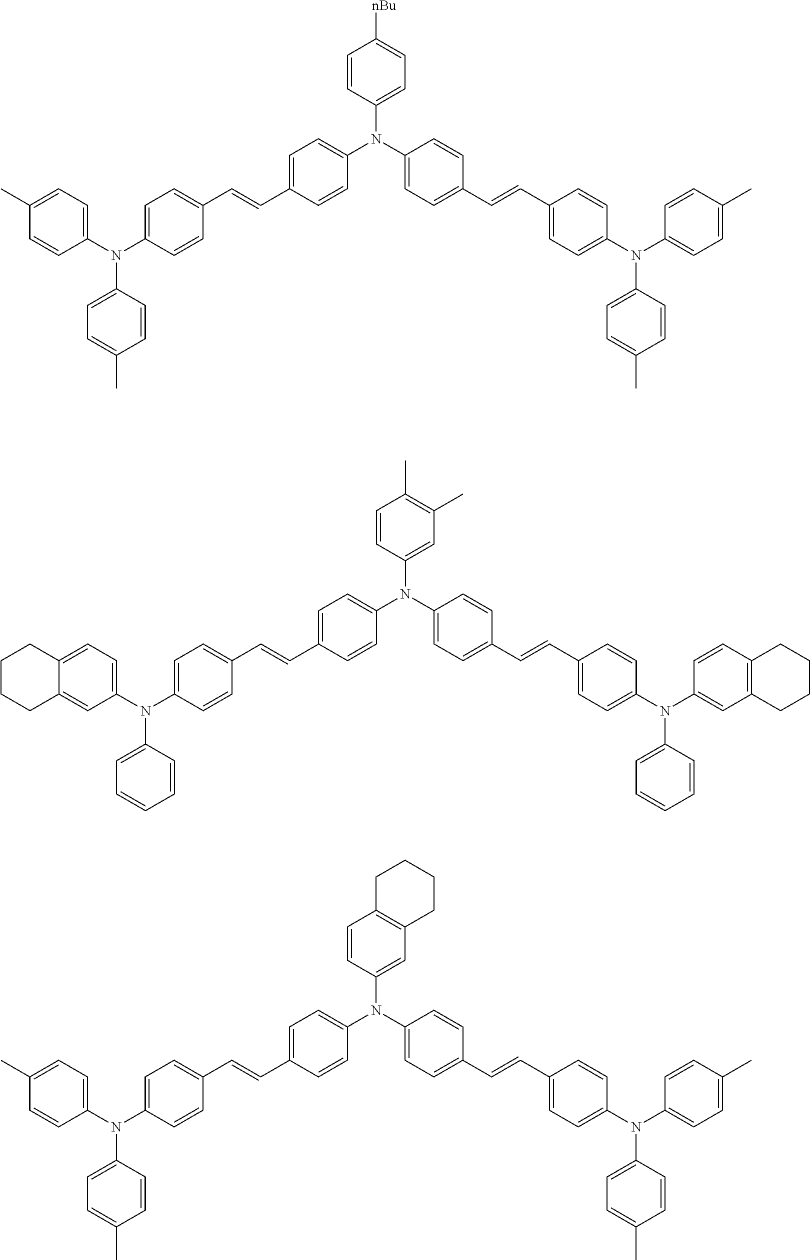

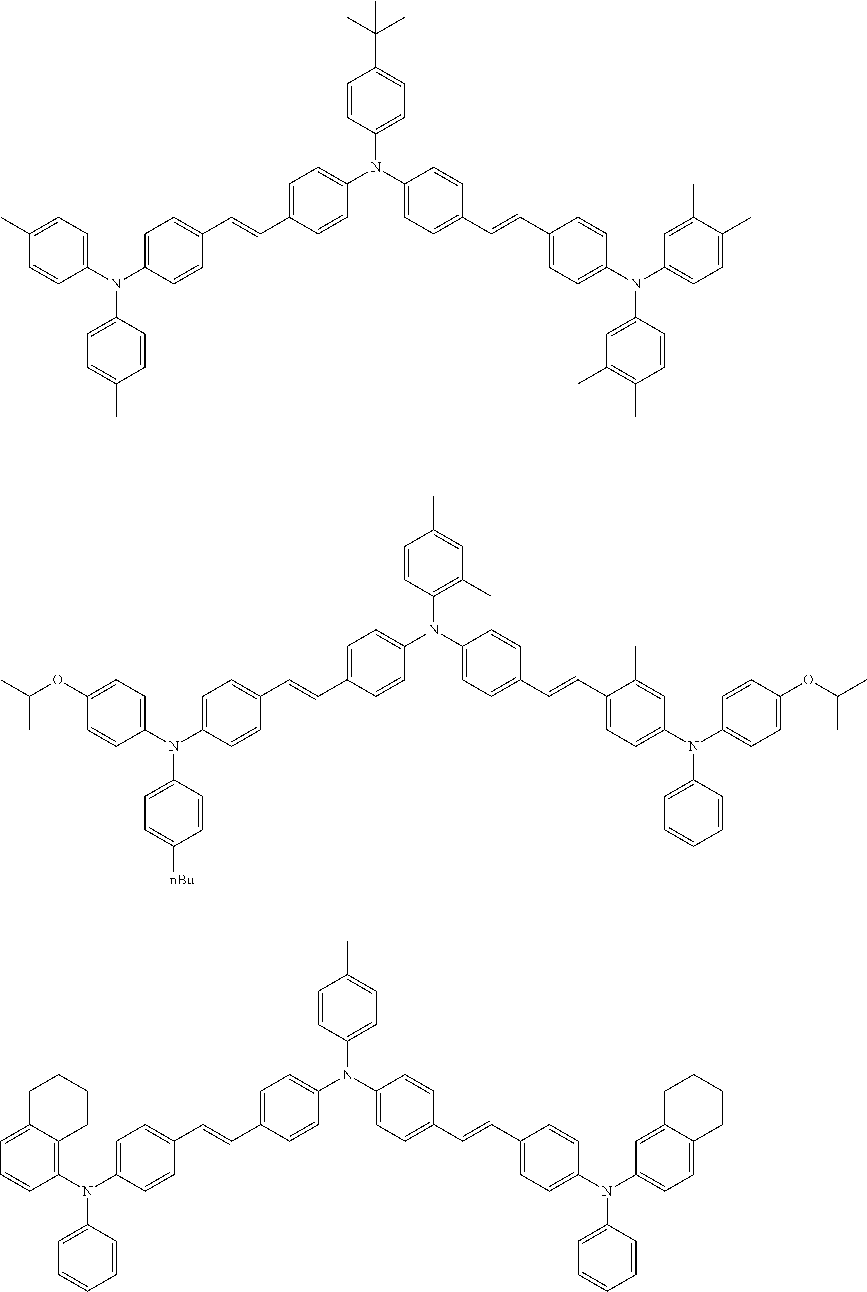

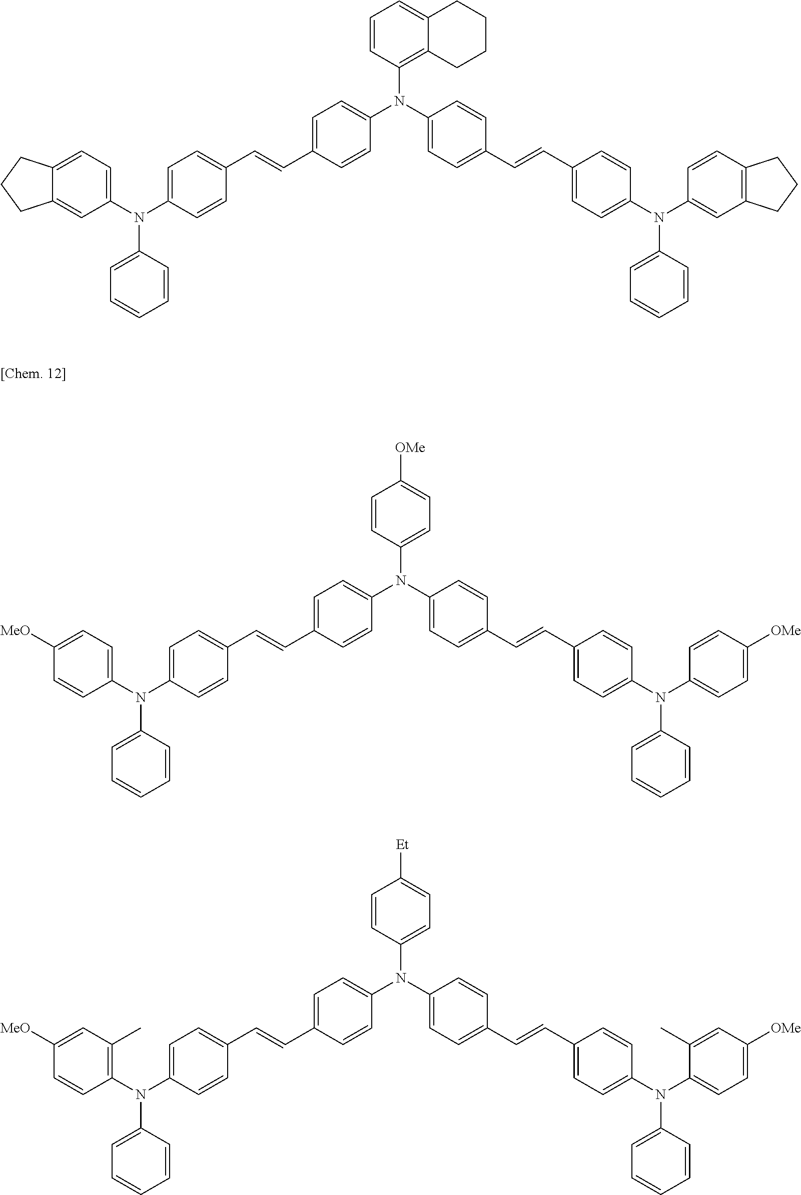 [SMILES: C(=C\c1ccc(N(c2ccc(/C=C/c3ccc(N(c4ccccc4)c4ccc5c(c4)CCC5)cc3)cc2)c2cccc3c2CCCC3)cc1)/c1ccc(N(c2ccccc2)c2ccc3c(c2)CCC3)cc1 ; COc1ccc(N(c2ccccc2)c2ccc(/C=C/c3ccc(N(c4ccc(/C=C/c5ccc(N(c6ccccc6)c6ccc(OC)cc6)cc5)cc4)c4ccc(OC)cc4)cc3)cc2)cc1 ; CCc1ccc(N(c2ccc(/C=C/c3ccc(N(c4ccccc4)c4ccc(OC)cc4C)cc3)cc2)c2ccc(/C=C/c3ccc(N(c4ccccc4)c4ccc(OC)cc4C)cc3)cc2)cc1]

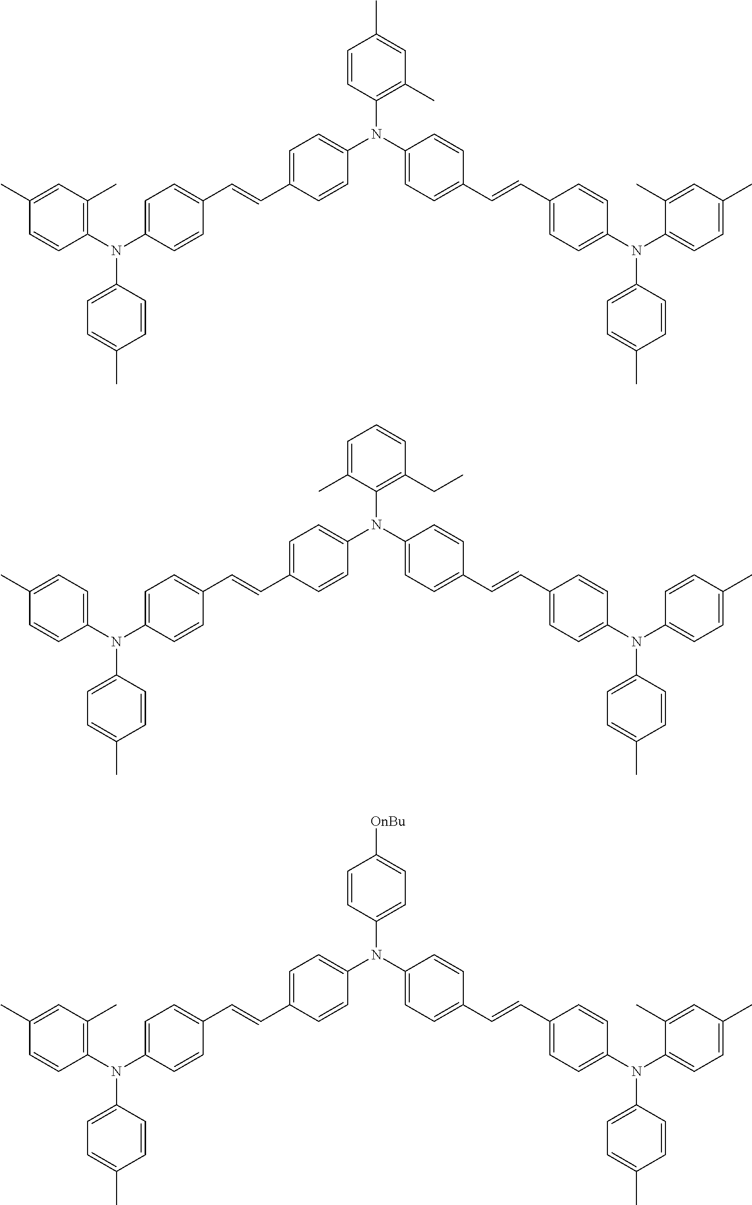

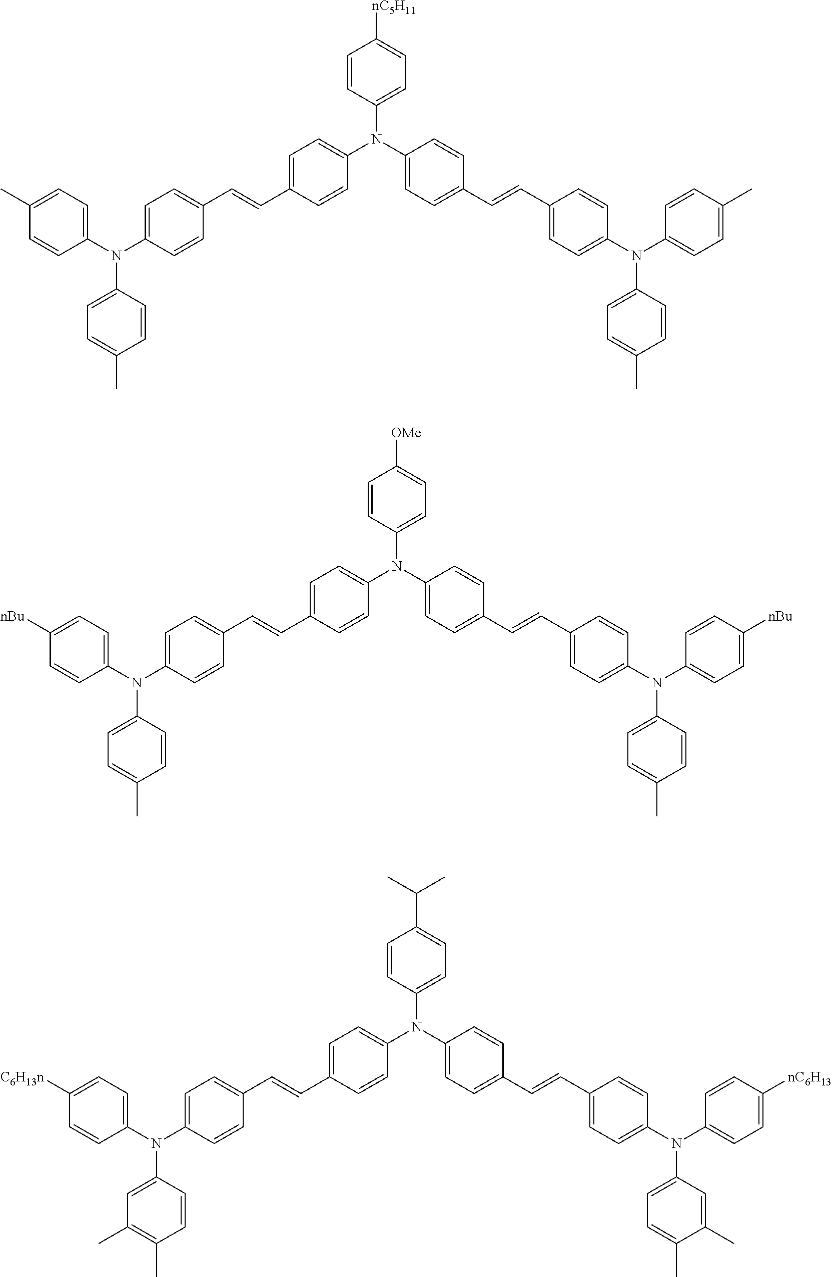

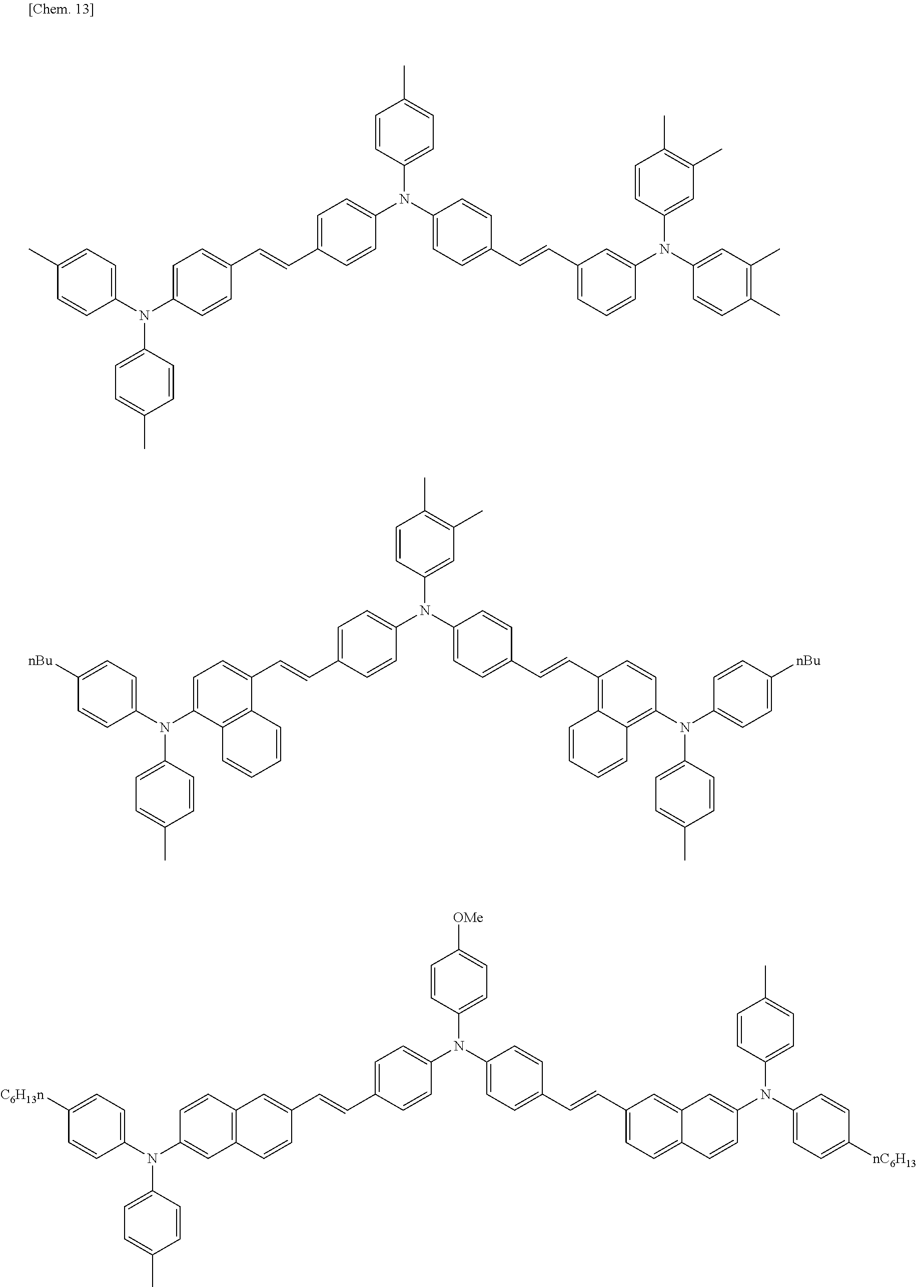

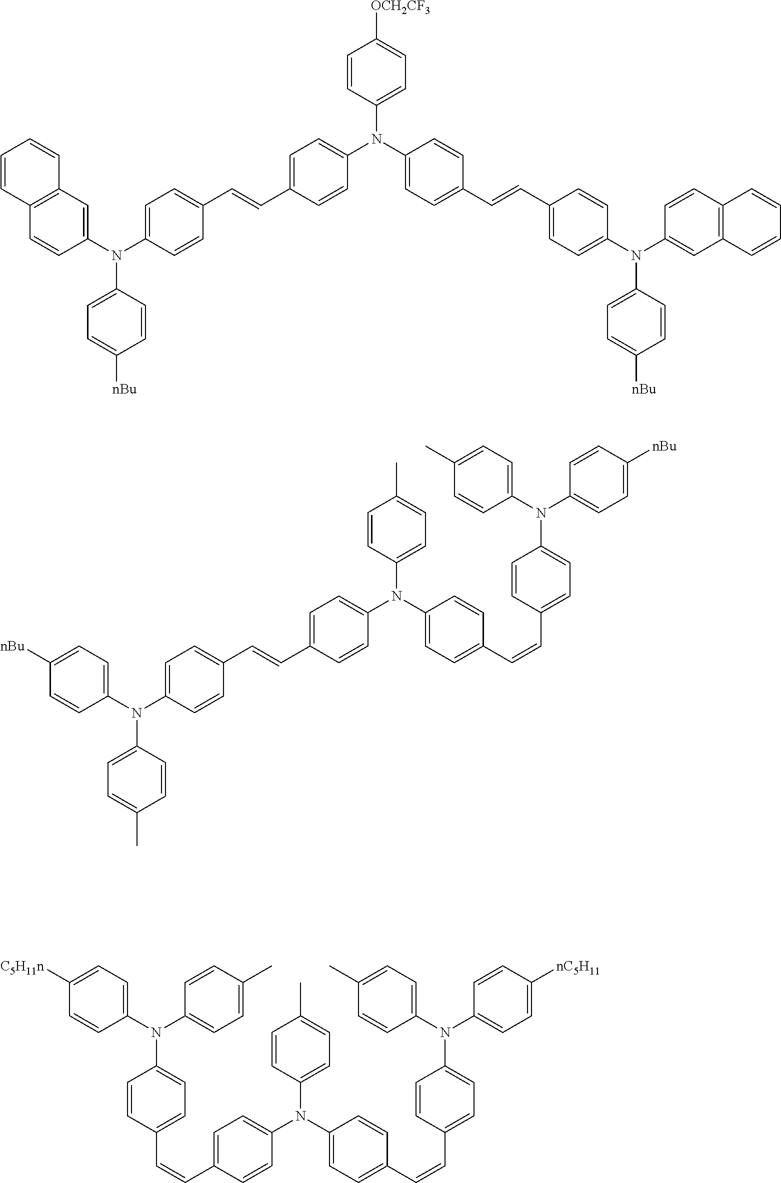

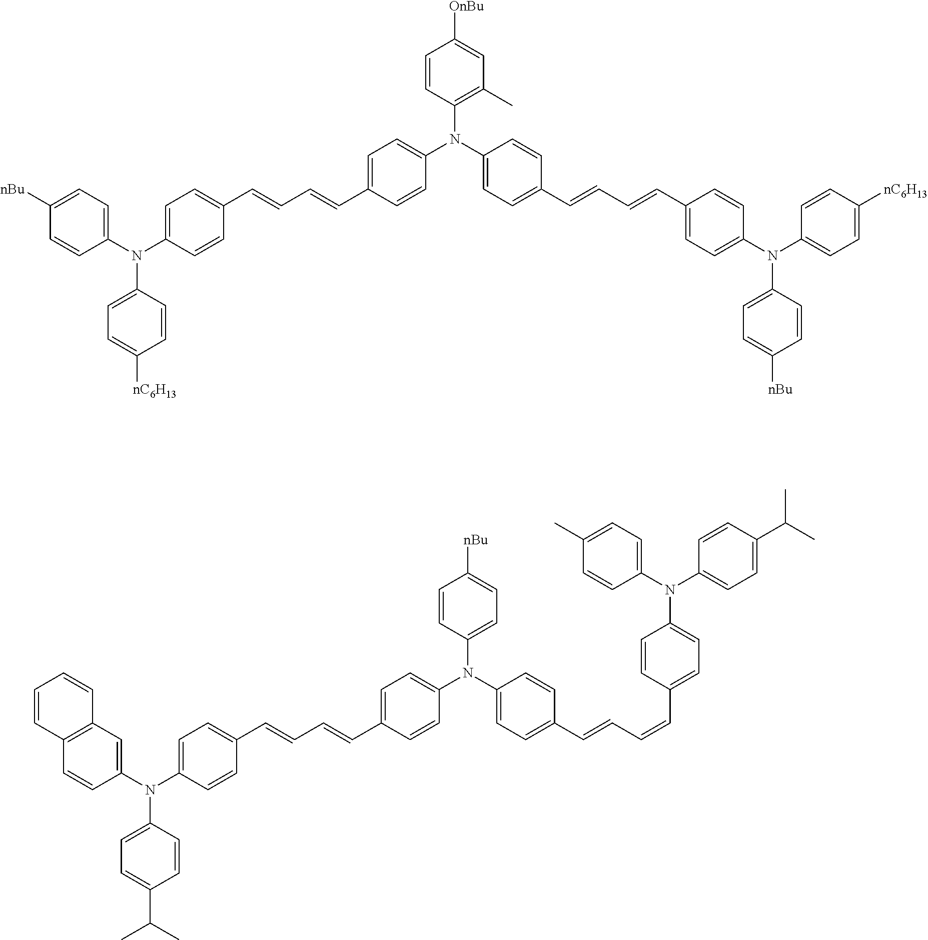

### <Production Method for Charge-Transporting Substance in the Invention>

The above-exemplified charge-transporting substances may be produced according to the schemes described below.

### (Scheme 1)

The above-mentioned compounds are referred to as examples. For example, a compound having a triphenylamine skeleton having a formyl group may be reacted with a phosphate compound having a triphenylamine skeleton to give the intended compound.

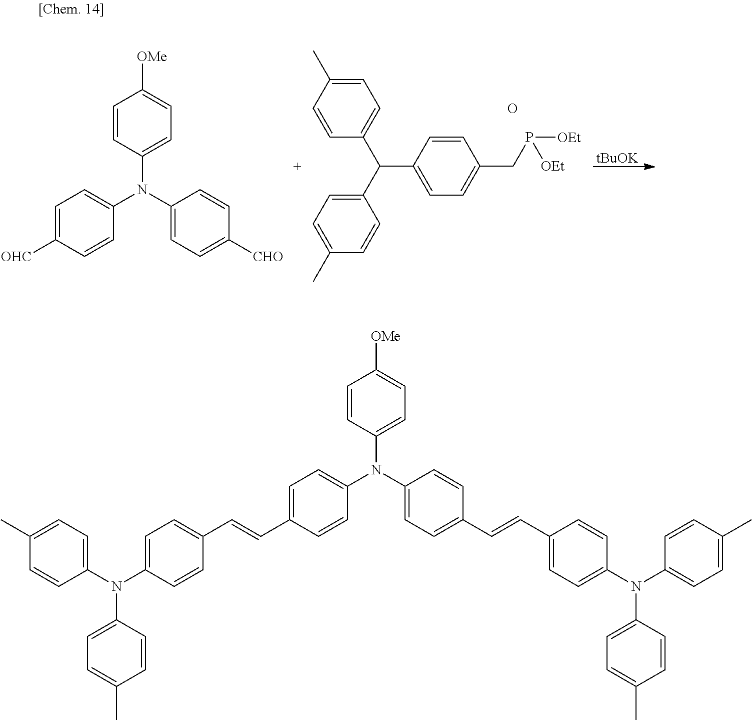

### (Scheme 2)

As another production method, a triphenylamine derivative having a halogen atom as mentioned below may be reacted with an aniline compound through coupling to give the intended compound.

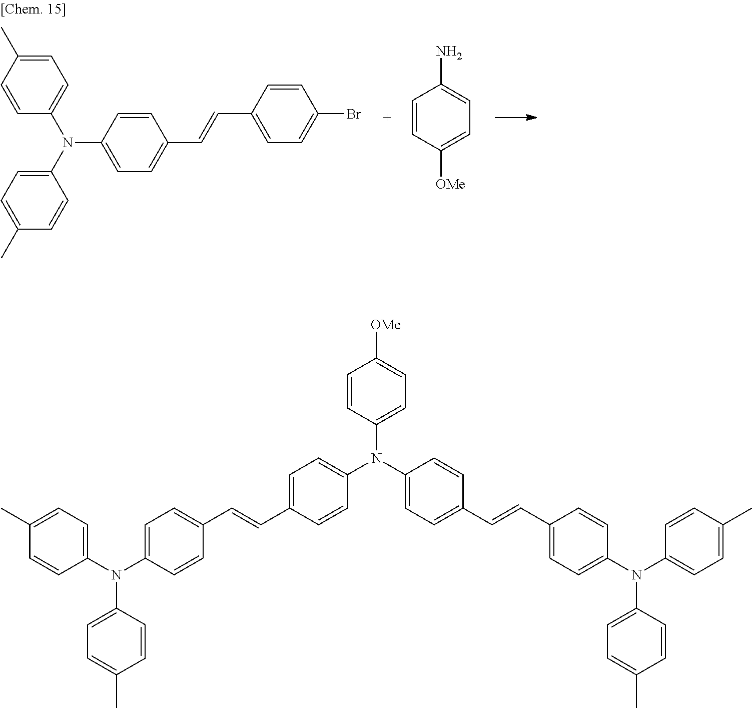

As the charge-transporting substance, preferred is a compound to be obtained through coupling reaction between a triphenylamine derivative having a halogen atom and an aniline compound. The compound can be synthesized not almost using a phosphorus compound having some influence on charge transportation, and the yield thereof is high, and therefore, the compound can maintain high-level electric characteristics almost free from any side reaction with the amine compound in the present invention. As the catalyst, usable is copper, zinc, palladium or the like, but palladium is preferred from the viewpoint of the production yield.

The HOMO energy level (E_homo) of the charge-transporting substance in the present invention, as calculated in a structure optimization calculation mode using B3LYP/6-31G (d,p) is generally E_homo >−4.63 (eV), preferably E_homo >−4.60 (eV), more preferably E_homo >−4.50 (eV). The compound having a higher HOMO energy level can provide a more excellent electrophotographic photoreceptor having a lower potential after exposure. On the other hand, however, when E_homo is too high, there may occur troubles of gas resistance reduction, ghost generation, etc., and therefore, in general, E_homo <−4.20 (eV), preferably E_homo <−4.25 (eV), more preferably E_homo <−4.30 (eV).

In the present invention, the HOMO energy level (E-homo) was determined by obtaining the stable structure through structural optimization calculation using B3LYP a type of density functional formalism (see A. D. Becke, J. Chem. Phys. 98, 5648 (1993), C. Lee, W. Yang, and R. G. Parr, Phys. Rev. B37, 785 (1988) and B. Miehlich, A. Savin, H. Stoll, and H. Preuss, Chem. Phys. Lett. 157, 200 (1989)). In this, as the basis function, used was 6-31 G (d,p), that is, 6-31 G with polarization functions added thereto (see R. Ditchfield, W. J. Hehre, and J. A. Pople, J. Chem. Phys. 54, 724 (1971), W. J. Hehre, R. Ditchfield, and J. A. Pople, J. Chem. Phys. 56, 2257 (1972), P. C. Hariharan and J. A. Pople, Mol. Phys. 27, 209 (1974), M. S. Gordon, Chem. Phys. Lett. 76, 163 (1980), P. C. Hariharan and J. A. Pople, Theo. Chim. Acta 28, 213 (1973), J. P. Blaudeau, M. P. McGrath, L. A. Curtiss, and L. Radom, J. Chem. Phys. 107, 5016 (1997), M. M. Francl, W. J. Pietro, W. J. Hehre, J. S. Binkley, D. J. DeFrees, J. A. Pople, and M. S. Gordon, J. Chem. Phys. 77, 3654 (1982), R. C. Binning Jr. and L. A. Curtiss, J. Comp. Chem. 11, 1206 (1990), V. A. Rassolov, J. A. Pople, M. A. Ratner, and T. L. Windus, J. Chem. Phys. 109, 1223 (1998), and V. A. Rassolov, M. A. Ratner, J. A. Pople, P. C. Redfern, and L. A. Curtiss, J. Comp. Chem. 22, 976 (2001)). In the present invention, B3LYP calculation using 6-31G (d,p) is referred to as B3LYP/6-31G (d,p).

The program used in the B3LYP/6-31G (d,p) calculation in the present invention is Gaussian 03, Revision D.01 (M. J. Frisch, G. W. Trucks, H. B. Schlegel, G. E. Scuseria, M. A. Robb, J. R. Cheeseman, J. A. Montgomery, Jr., T. Vreven, K. N. Kudin, J. C. Burant, J. M. Millam, S. S. Lyengar, J. Tomasi, V. Barone, B. Mennucci, M. Cossi, G. Scalmani, N. Rega, G. A. Petersson, H. Nakatsuji, M. Hada, M. Ehara, K. Toyota, R. Fukuda, J. Hasegawa, M. Ishida, T. Nakajima, Y. Honda, O. Kitao, H. Nakai, M. Klene, X. Li, J. E. Knox, H. P. Ilratchian, J. B. Cross, V. Bakken, C. Adamo, J. Jaramillo, R. Gomperts, R. E. Stratmann, O. Yazyev, A. J. Austin, R. Cammi, C. Pomelli, J. W. Ochterski, P. Y. Ayala, K. Morokuma, G. A. Voth, P. Salvador, J. J. Dannenberg, V. G. Zakrzewski, S. Dapprich, A. D. Daniels, M. C. Strain, O. Farkas, D. K. Malick, A. D. Rabuck, K. Raghavachari, J. B. Foresman, J. V. Ortiz, Q. Cui, A. G. Baboul, S. Clifford, J. Cioslowski, B. B. Stefanov, G. Liu, A. Liashenko, P. Piskorz, I. Komaromi, R. L. Martin, D. J. Fox, T. Keith, M. A. Al-Laham, C. Y. Peng, A. Nanayakkara, M. Challacombe, P. M. W. Gill, B. Johnson, W. Chen, M. W. Wong, C. Gonzalez, and J. A. Pople, Gaussian, Inc., Wallingford Conn., 2004).

For example, general charge-transporting substances have a value as in Table 1.

TABLE 1

| | E_homo |
|---|---|
| Charge-Transporting Substance | (eV) |
| 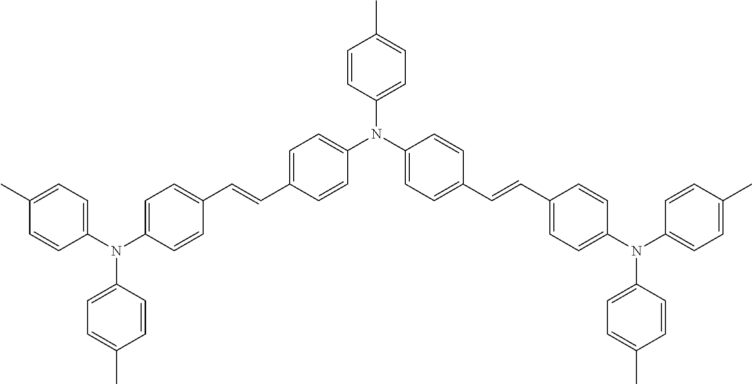 | −4.40 |
| 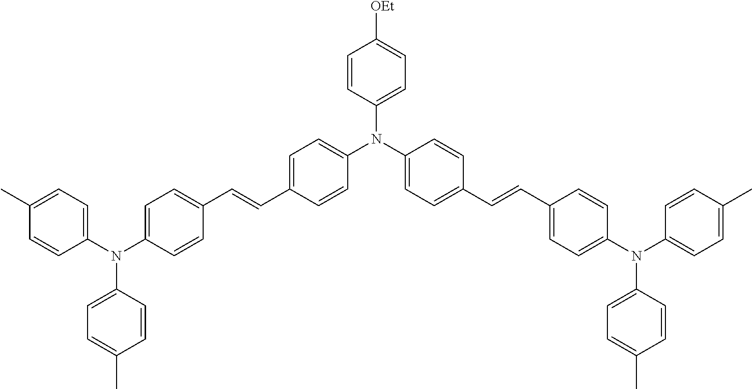 | −4.35 |

Regarding the lower limit thereof, the molecular weight of the charge-transporting substance in the present invention is 600 or more, and for promoting the intramolecular electron localization to effectively enhance the charge transportation capability of the substance, the molecular weight is more preferably 650 or more. From the viewpoint of the miscibility of the substance, the upper limit of the molecular weight is 1500 or less, preferably 1200 or less, more preferably 1000 or less. The molecular weight as referred to herein indicates the relative mass of the molecule, and is a value determined through calculation of the sum total of the atomic weight of the atoms constituting the molecule. As the atomic weight, used is the standard atomic weight published by IUPAC.

The structure of the charge-transporting substance that may be additionally used here is not specifically defined, and there are mentioned electron-donating materials and the like, such as aromatic amine derivatives, stilbene derivatives, butadiene derivatives, hydrazone derivatives, carbazole derivatives, aniline derivatives, enamine derivatives, and composites of different types of those compounds bonding to each other, as well as polymers having a residue of those compounds in the main chain or in the side chains, etc. Of those, preferred are aromatic amine derivatives, stilbene derivatives, hydrazone derivatives, enamine derivatives, and composites of different types of those compounds bonding to each other. Above all, preferred are composites of enamine derivatives and aromatic amines bonding to each other.

The charge-transporting substance represented by the above formula (2) may be combined with any other charge-transporting substance for use herein, but for sufficiently exhibiting the above-mentioned effects of the present invention, in general, the amount of the charge-transporting substance represented by the formula (2) is generally 10% by mass or more, in the entire amount of all charge-transporting substances, preferably 50% by mass or more, more preferably 80% by mass or more. Especially preferably, only the charge-transporting substance represented by the formula (2) is used as the hole-transporting substance.

For sufficiently exhibiting the above-mentioned effects of the present invention, the content of the charge-transporting substance represented by the formula (2) is generally 25 parts by mass or more, relative to 100 parts by mass of the binder resin in the same layer, preferably 30 parts by mass or more, more preferably 40 parts by mass or more. The charge-transporting substance represented by the formula (2) has the advantage that, even though the amount thereof is small, the substance can exhibit the effect. Therefore, in consideration of the abrasion resistance of the layer, the content of the substance is preferably 100 parts by mass or less, more preferably 80 parts by mass or less, even more preferably 50 parts by mass or less.

### <Single-Layer Photosensitive Layer>

The single-layer photosensitive layer is formed using a binder resin in addition to the charge-generating substance and the charge-transporting substance, like the charge transport layer in the functional separation-type photoreceptor. Concretely, a charge-generating substance, a charge-transporting substance and a binder resin are dissolved or dispersed in a solvent to prepare a coating liquid, and the coating liquid is applied onto a conductive support (in a case where an undercoat layer is provided, onto the undercoat layer), and then dried thereon to form the intended layer.

The type of the charge-transporting substance and the binder resin and the ratio thereof to be used are the same as those described hereinabove for the charge transport layer in the laminate-type photoreceptor. In the charge transport medium that comprises the charge-transporting substance and the binder resin, the charge-generating substance is further dispersed.

As the charge-generating substance, usable is the same one as that described for the charge generation layer in the laminate-type photoreceptor. However, in the photosensitive layer of the single-layer photoreceptor, the particle size of the charge-generating substance must be sufficiently small. Concretely, the particle size is generally 1 μM or less, preferably 0.5 μm or less.

When the amount of the charge-generating substance to be dispersed in the single-layer photosensitive layer is too small, then a sufficient sensitivity could not be realized, but when too large, then there may occur some troubles of chargeability reduction and sensitivity reduction. Accordingly, the amount of the substance is generally 0.5% by mass or more relative to the entire mass of the single-layer photosensitive layer, preferably 1% by mass or more, and is generally 50% by mass or less, preferably 20% by mass or less.

Regarding the ratio of the binder resin to the charge-generating substance to be in the single-layer photosensitive layer, the amount of the charge-generating substance is generally 0.1 parts by mass or more relative to 100 parts by mass of the binder resin, preferably 1 part by mass or more, and is generally 30 parts by mass or less, preferably 10 parts by mass or less.

The thickness of the single-layer photosensitive layer is generally 5 μm or more, preferably 10 μm or more, and is generally 100 μm or less, preferably 50 μm or less.

In the photosensitive layer or in each layer constituting the layer in both the laminate-type photoreceptor and the single-layer photoreceptor, any known antioxidant, plasticizer, UV absorbent, electron-attracting compound, leveling gent, visible light-blocking agent and the like may be incorporated for the purpose of improving the film formability, the flexibility, the coatability, the pollution resistance, the gas resistance and the lightfastness of the layer.

### <Other Functional Layers>

In the photosensitive layer or in each layer constituting the layer in both the laminate-type photoreceptor and the single-layer photoreceptor, any known additive such as antioxidant, plasticizer, UV absorbent, electron-attracting compound, leveling gent, visible light-blocking agent and the like may be incorporated for the purpose of improving the film formability, the flexibility, the coatability, the pollution resistance, the gas resistance and the lightfastness of the layer.

Both in the laminate-type photoreceptor and the single-layer photoreceptor, the photosensitive layer formed according to the above-mentioned process may be the uppermost layer, or that is, the surface layer, but any additional layer may be provided thereon to be the surface layer.

For example, for the purpose of preventing the photosensitive layer from being worn away and for preventing or retarding the photosensitive layer from being deteriorated by the discharge product to be generated from a charger or the like, a protective layer may be provided.

The protective layer may be formed of a conductive material put in a suitable binder resin, or may be formed of a copolymer using a charge-transporting compound such as a triphenylamine skeleton or the like described in JP-A 9-190004.

As the conductive material for use in the protective layer, usable are aromatic amino compounds such as TPD (N,N′-diphenyl-N,N′-bis(m-tolyl)benzidine), etc., and metal oxides such as antimony oxide, indium oxide, tin oxide, titanium oxide, tin oxide-antimony oxide, aluminium oxide, zinc oxide, etc., but these are not limitative.

As the binder resin to be in the protective layer, usable are any known resins such as polyamide resins, polyurethane resins, polyester resins, epoxy resins, polyketone resins, polycarbonate resins, polyvinylketone resins, polystyrene resins, polyacrylamide resins, siloxane resins, etc. In addition, also usable are copolymers of a charge-transporting skeleton such as a triphenylamine skeleton or the like and the above-mentioned resins, as described in JP-A 9-190004.

The electric resistance of the protective layer generally falls within a range of from 10⁹ Ω·cm to 10¹⁴ Ω·cm. When the electric resistance is higher than the range, then the residual potential may increase and the image to be formed would be much fogged. On the other hand, when lower than the range, there may occur image blurring and resolution reduction. The protective layer must be so planned that the layer does not substantially block the light applied to the photoreceptor in imagewise exposure thereof. In addition, for the purpose of increasing the abrasion resistance of the photoreceptor surface, for reducing the surface from being worn away, and for increasing the toner transfer efficiency from the photoreceptor to the transfer belt and to paper, a fluororesin, a silicone resin, a polyethylene resin or the like or particles of such a resin as well as particles of an inorganic compound may be incorporated in the surface layer. As the case may be, an additional layer that contains such a resin or particles may be provided as a surface layer.

### <Formation Method for Layers>

The layers constituting the photoreceptor may be formed by applying the coating liquid prepared by dissolving or dispersing the constituent substances in a solvent, onto a conductive support according to a known method of dip coating, spray coating, nozzle coating, bar coating, roll coating, blade coating or the like, in which coating and drying steps are repeated for every layer.

The solvent and the dispersion medium for use in preparing the coating liquid are not specifically defined, and as examples thereof, there are mentioned alcohols such as methanol, ethanol, propanol, 2-methoxyethanol, etc., ethers such as tetrahydrofuran, 1,4-dioxane, dimethoxyethane, etc., esters such as methyl formate, ethyl acetate, etc., ketones such as acetone, methyl ethyl ketone, cyclohexanone, 4-methoxy-4-methyl-2-pentanone, etc., aromatic hydrocarbons such as benzene, toluene, xylene, etc., chlorohydrocarbons such as dichloromethane, chloroform, 1,2-dichloroethane, 1,1,2-trichloroethane, 1,1,1-trichloroethane, tetrachloroethane, 1,2-dichloropropane, trichloroethylene, etc., nitrogen-containing compounds such as n-butylamine, isopropanolamine, diethylamine, triethanolamine, ethylenediamine, triethylenediamine, etc., aprotic polar solvents such as acetonitrile, N-methylpyrrolidone, N,N-dimethylformamide, dimethyl sulfoxide, etc. One alone or two or more different types of these may be used either singly or as combined in any desired combination manner.

The amount of the solvent or the dispersion medium to be used is not specifically defined. It is desirable that, in consideration of the object of each layer and the property of the solvent or the dispersion medium selected, the amount is suitably controlled so that the physical properties such as the solid concentration and the viscosity of the coating liquid could fall within a desired range.

For example, in the case of the charge transport layer in the single-layer photoreceptor and the functional separation-type photoreceptor, the solid concentration in the coating liquid is to fall within a range of generally 5% by mass or more, preferably 10% by mass or more, generally 40% by mass or less, preferably 35% by mass or less. The viscosity of the coating liquid is controlled to be generally 10 mPa·s or more, preferably 50 mPa·s or more and generally 500 mPa·s or less, preferably 400 mPa·s or less, at the temperature in use of the liquid.

In the case of the charge generation layer of the laminate-type photoreceptor, the solid concentration of the coating liquid is controlled to be generally 0.1% by mass or more, preferably 1% by mass or more, and generally 15% by mass or less, preferably 10% by mass or less. The viscosity of the coating liquid is to be generally 0.01 mPa·s or more, preferably 0.1 mPa·s or more and generally 20 mPa·s or less, preferably 10 mPa·s or less, at the temperature in use of the liquid.

As the method of coating with the coating liquid, there are mentioned a dip coating method, a spray coating method, a spinner coating method, a bead coating method, a wire bar coating method, a blade coating method, a roller coating method, an air knife coating method, a curtain coating method, etc. Any other known coating method is also employable here.

Preferably, the coating liquid is dried first at room temperature to be set to touch, and is thereafter further dried by heating statically or under aeration, generally in a temperature range of from 30° C. to 200° C. for a period of from 1 minute to 2 hours. The heating temperature may be kept constant, or may be varied during the process of heating.

### <Surface Resistance Value>

The photoreceptor is exposed to light from a white fluorescent lamp for 10 minutes in such a controlled manner that the light intensity on the photoreceptor surface could be 2000 lux. The surface resistivity after the exposure is referred to as Sr¹, and the surface resistivity before the exposure is referred to as Sr². Preferably, the photoreceptor satisfies the following formula:

|Sr¹−Sr²|≦7.0×10¹²

From the viewpoint of preventing image blurring and securing good dot reproducibility, the following is more preferred.

|Sr¹−Sr²|≦6.6×10¹²

The above-mentioned formula means that the surface resistivity change after white light irradiation is small. The photoreceptor of which the surface resistivity change is small can prevent image blurring and can secure good dot reproducibility. For example, when the photoreceptor is taken out of an image formation device or the like, the photoreceptor satisfying the above-mentioned formula could prevent occurrence of image failures. For satisfying the above-mentioned formula, for example, employable here is the method of incorporating the compound represented by the formula (1) and the charge-transporting substance represented by the formula (2) into the photosensitive layer.

The surface resistivity may be measured on a drum-type photoreceptor or on a sheet-type photoreceptor. For example, a liquid for the charge transport layer (in a case of a single-layer photoreceptor, a liquid for the photosensitive layer) is applied onto a 100-μm PET film so that the thickness of the coating film after dried could be 20 μm thereby preparing a charge transport layer sample, and using a high resistivity meter, Hiresta-UP, MCP-HT450 (by Mitsubishi Chemical), the photoreceptor was measured under the detailed condition mentioned below.

### Probe: UR100

### Applied Voltage: 1000 V

Measurement Time: 60 seconds

### <Image Formation Device>

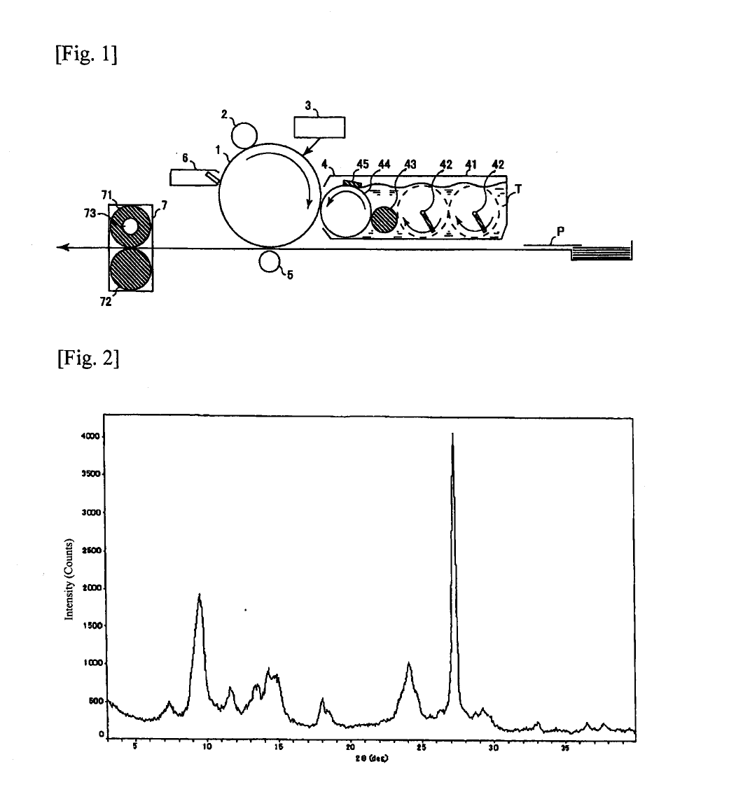

Next described are embodiments of the image formation device using the electrophotographic photoreceptor of the present invention (the image formation device of the present invention) with reference to FIG. 1 showing the substantial part configuration of the device. However, the embodiments of the present invention are not limited to the following description, and not overstepping the scope and the spirit thereof, the present invention may be carried out in any modified manner.

As shown in FIG. 1, the image formation device is composed to comprise an electrophotographic photoreceptor 1, a charging device 2, an exposure device 3 and a development device 4, and is optionally provided with a transfer device 5, a cleaning device 6 and a fixation device 7.

The electrophotographic photoreceptor 1 is not specifically defined so far as it is the above-mentioned electrophotographic photoreceptor of the present invention, and FIG. 1 shows, as one example thereof, a drum-type photoreceptor a photosensitive layer formed on the surface of a cylindrical conductive support. Along the outer periphery of the electrophotographic photoreceptor 1, there are arranged the charging device 2, the exposure device 3, the development device 4, the transfer device 5 and the cleaning device 6.

The charging device 2 is for charging the electrophotographic photoreceptor 1, and uniformly charges the surface of the electrophotographic photoreceptor 1 to a predetermined potential. As the charging device, well used is a corona charging device such as corotron, scorotron or the like, or a direct charging device of charging the surface of a photoreceptor through direct contact with a voltage-applied charging member (contact charging device), etc. Examples of the direct charging device include a charging roller, a charging brush, etc. FIG. 1 shows a roller-type charging device (charging roller) as one example of the charging device 2. As the direct charging means, employable here are both one accompanied by aerial discharge and one for injection charging not accompanied by aerial discharge. As the voltage to be applied in charging, a direct current alone may be used, but also usable is a superimposed voltage of a direct current and an alternate current. In the case of a corona charging device such as corotron, scorotron or the like, the effects of the present invention are remarkable since the device can readily generate ozone.

Not specifically defined in point of the type thereof, the exposure device 3 may be any one capable of exposing the electrophotographic photoreceptor 1 to light to form an electrostatic lateen image on the photosensitive surface of the electrophotographic photoreceptor 1. Specific examples of the device include a halogen lamp, a fluorescent lamp, a laser such as a semiconductor laser, a He—Ne laser or the like, and LED, etc. An intra-photoreceptor exposure system is also employable here. Any light may be usable for the exposure. For example, the photoreceptor may be exposed to a monochromatic light having a wavelength of 780 nm, or to a monochromatic light relatively near to a short wavelength in a range of from 600 to 700 nm, or to a monochromatic light at a short wavelength falling within a range of from 380 to 500 nm.

Not specifically defined in point of the type thereof, the development device 4 may be any of a dry development system of cascade development, one-component insulating toner development, one-component conductive toner development, two-component magnetic brush development or the like, or a wet development system, etc. In FIG. 1, the development device 4 comprises a development tank 41, an agitator 42, a feed roller 43, a development roller 44 and a control member 45, and is so designed that a toner T is stored inside the development tank 41. If desired, a refill device (not shown) for refilling the toner T may be attached to the development device 4. The refill device is so designed that the toner T can be supplied from a container such as a bottle, a cartridge or the like. The feed roller 43 is formed of a conductive sponge or the like. The development roller 44 is a metal roll of iron, stainless steel, aluminum, nickel or the like or a resin roll constructed by coating such a metal roll with a silicone resin, an urethane resin, a fluororesin or the like. If desired, the surface of the development roller 44 may be smoothed or roughened. The development roller 44 is arranged between the electrophotographic photoreceptor 1 and the feed roller 43 and is kept in contact with both the electrophotographic photoreceptor 1 and the feed roller 43. The feed roller 43 and the development roller 44 are rotated by a revolution drive mechanism (not shown). The feed roller 43 carries the stored toner T and supplies it to the development roller 44. The development roller 44 carries the toner T fed by the feed roller 43, and brings it into contact with the surface of the electrophotographic photoreceptor 1.

The control member 45 is formed of a resin blade of a silicone resin, an urethane resin or the like, or a metal blade of stainless steel, aluminium, copper, brass, phosphor bronze or the like, or a blade constructed by coating such a metal blade with a resin, etc. The control member 45 is kept in contact with the development roller 44, and is pressed against the development roller 44 by a spring or the like, under a predetermined pressing pressure (in general, the blade linear pressure is from 5 to 500 g/cm). If desired, the control member 45 may be so designed as to have a function of charging the toner T by the frictional electrification with the toner T.

The agitator 42 is each rotated by a revolution drive mechanism, thereby to stir the toner T and to transport the toner T to the side of the feed roller 43. Multiple agitators 42 may be arranged, differing in the blade shape and the size.

The type of the toner T may be an arbitrary one. Not only a powdery toner but also a polymerization toner prepared according to a suspension polymerization, an emulsion polymerization or the like may be employed here. In particular, in a case of using a polymerization toner, preferred are small particles having a particle size of from 4 to 8 μm or so. The form of the toner particles may vary, including a nearly spherical one, a non-spherical one such as a potato-like one. The polymerization toner is excellent in charging uniformity and transferability, and is favorably used for forming high-quality images.

The transfer device 5 is not specifically defined in point of the type thereof. Any device is employable here, using any system of an electrostatic transfer method of corona transfer, roller transfer, belt transfer or the like, as well as a pressure transfer method, or an adhesive transfer method. Here, the transfer device 5 comprises a transfer charger, a transfer roller, a transfer belt or the like arranged to face the electrophotographic photoreceptor 1. To the transfer device 5, a predetermined voltage (transfer voltage) of which the polarity is opposite to that of the charging potential of the toner T is applied so that the toner image formed on the electrophotographic photoreceptor 1 is transferred to recording paper (copy paper, medium) P.

The cleaning device 6 is not specifically defined, and any cleaning device is employable here, including a brush cleaner, a magnetic brush cleaner, an electrostatic brush cleaner, a magnetic roller cleaner, a blade cleaner, etc. The cleaning device 6 is to scrape off the residual toner adhering to the photoreceptor 1 with the cleaning member thereof, to thereby recover the residual toner. However, in a case where there exists a little or little residual toner on the surface of the photoreceptor, the cleaning device 6 may be omitted.

The fixation device 7 comprises an upper fixation member (fixation roller) 71 and a lower fixation member (fixation roller) 72, and a heating device 73 is arranged inside the fixation member 71 or 72. FIG. 1 shows a case where the heating device 73 is arranged inside the upper fixation member 71. For the upper fixation member 71 and the lower fixation member 72, usable here are known thermal fixation members such as a fixation roll in which the metallic core tube of stainless steel, aluminium or the like is covered with a silicone rubber, as well as a fixation roll further covered with a Teflon (registered trademark) resin, a fixation sheet, etc. In addition, the fixation members 71 and 72 may be so designed that they can supply a release agent such as a silicone oil or the like for improving the releasability of the medium, or may be so designed that they could forcedly impart pressure to each other by a spring or the like.

The toner transferred on the recording paper P is, while running between the upper fixation member 71 that has been heated up to a predetermined temperature and the lower fixation member 72, heated to be in a molten state, and after having passed through it and cooled, the toner is fixed on the recording paper P.

The fixation device is not also specifically defined in point of the type thereof. In addition to the device used here, any other fixation device to be driven according to a system of thermal roller fixation, flash fixation, oven fixation, pressure fixation or the like may be provided here.

In the electrophotographic device designed in the manner as above, an image is recorded as follows. First, the surface of the photoreceptor 1 (photosensitive surface) is charged at a predetermined potential (for example, at −600 V) by the charging device 2. In this stage, the photoreceptor may be charged by a direct-current voltage or may be charged by a superimposed voltage of a direct current voltage and an alternate current voltage.

Subsequently, the photosensitive surface of the charged photoreceptor 1 is exposed to light in accordance with the image to be recorded, by the exposure device 3, thereby forming an electrostatic latent image on the photosensitive surface. With that, the electrostatic latent image formed on the photosensitive surface of the photoreceptor 1 is then developed by the development device 4.

In the development device 4, the toner T fed by the feed roller 43 is formed into a thin film by the control member (development blade) 45, and is frictionally charged at a predetermined polarity (here, at a homopolarity that is the same as the polarity of the charge potential of the photoreceptor 1, or that is, negative polarity), and while carried on the development roller 44, the toner is thus conveyed and is brought into contact with the surface of the photoreceptor 1.

When the charged toner T that has been carried on the development roller 44 is brought into contact with the surface of the photoreceptor 1, then the toner image corresponding to the electrostatic latent image is formed on the photosensitive surface of the photoreceptor 1. The toner image is then transferred to the recording paper P by the transfer device 5. Subsequently, the toner not transferred but remaining on the photosensitive surface of the photoreceptor 1 is removed by the cleaning device 6.

After transferred onto the recording paper P, the toner image is led to pass through the fixation device 7 and is thermally fixed on the recording paper P to give a final image thereon.

The image formation device may be so constructed that, in addition to the above-mentioned constitution, for example, a neutralization step may be carried out therein. The neutralization step is a step of neutralizing the electrophotographic photoreceptor by exposing it to light, and in the neutralization device, usable is a fluorescent lamp, LED or the like. The intensity of the light for neutralization is generally 3 times or more of the exposure energy of the exposure light, in many cases.

The image formation device may be further modified. For example, the device may be so designed as to be able to take an additional process of a pre-exposure step, a subsidiary charging step, etc., or may be so designed as to realize offset printing, or as to take a full-color tandem system using multiple types of toners.

The electrophotographic photoreceptor 1 may be combined with one or more of the charging device 2, the exposure device 3, the development device 4, the transfer device 5, the cleaning device 6 and the fixation device 7 to construct a process cartridge (hereinafter this may be suitably referred to as “electrophotographic photoreceptor cartridge”), and the electrophotographic photoreceptor cartridge may be designed to be detachable to the main body of the electrophotographic device such as a copier, a laser beam printer, etc. In this case, for example, in a case where the electrophotographic photoreceptor 1 or any other member is degraded, the electrophotographic photoreceptor cartridge is detached from the main body of the image formation device and a separate new electrophotographic photoreceptor cartridge is set in the main body of the image formation device, thereby facilitating the maintenance of the image formation device.

### EXAMPLES

The present invention is described in more detail hereinunder, with reference to Examples and Comparative Examples given below. The following Examples are for describing in detail the present invention, and the present invention is not restricted to the following Examples, not overstepping the scope and the spirit thereof. Unless otherwise specifically indicated, “part” used in Examples is “part by mass”.

### Example 1

### Electrophotographic Photoreceptor X1

A conductive support having, as formed on the surface of a biaxially-stretched polyethylene terephthalate resin film (thickness 75 μm), an aluminium-deposited layer (thickness 700 angstroms) was used. On the deposited layer of the support, an undercoat layer dispersion mentioned below was applied using a bar coater in such a manner that the thickness of the coating film could be, after dried, 1.25 μm and then dried to form an undercoat layer thereon.

A slurry prepared by mixing rutile-type titanium oxide having a mean primary particle size of 40 nm (Ishihara Sangyo's “TTO55N”) and 3% by mass, relative to the titanium oxide, of methyldimethoxysilane in a ball mill was dried, then washed with methanol and further dried to give a hydrophobized titanium oxide was dispersed in a mixed solvent of methanol/1-propanol in a ball mill to give a hydrophobized titanium oxide dispersion slurry. The slurry, a mixed solvent of methanol/1-propanol/toluene (mass ratio, 7/1/2), and pellets of a copolyamide of ε-caprolactam/bis(4-amino-3-methylphenyl)methane/hexamethylenediamine/decamethylene dicarboxylic acid/octadecamethylenedicarboxylic acid (composition mol %, 75/9.5/3/9.5/3) were stirred and mixed with heating to dissolve the polyamide pellets, then ultrasonically dispersed to give a dispersion containing hydrophobized titanium oxide/copolyamide in a mass ratio of 3/1 and having a solid concentration of 18.0%.

As a charge-generating material, 20 parts of oxytitanium phthalocyanine having a powdery X-ray diffraction spectral pattern with CuKα characteristic X-ray, as shown in FIGS. 2, and 280 parts of 1,2-dimethoxyethane were mixed, ground in a sand grind mill for 2 hours for dispersion through atomization. Subsequently, 400 parts of a 2.5% 1,2-dimethoxyethane solution of polyvinyl butyral (Denki Kagaku Kogyo's trade name “Denka Butyral” #6000C), and 170 parts of 1,2-dimethoxyethane were mixed to prepare a dispersion. The dispersion was applied onto the above-mentioned undercoat layer using a bar coater in such a manner that the thickness of the coating layer could be 0.4 μm, thereby forming a charge generation layer thereon.

Next, a liquid prepared by dissolving 40 parts of a charge-transporting substance (1) having a structure shown below (as synthesized using palladium and according to the method of the above-mentioned scheme 2), 100 parts of a binder resin (1) having a structure shown below (viscosity-average molecular weight: 37000), 1 part of the above-exemplified amine compound (1)-1, 4 parts of an antioxidant (1) having a structure shown below, and 0.05 parts of a silicone oil as a leveling agent, in 640 parts of a mixed solvent of tetrahydrofuran/toluene (8/2) was applied onto the above film and dried at 125° C. for 20 minutes in such a manner that the coating film could be, after dried, 18 μm to form a charge transport layer, thereby producing a photoreceptor. The photoreceptor is referred to as photoreceptor X1.

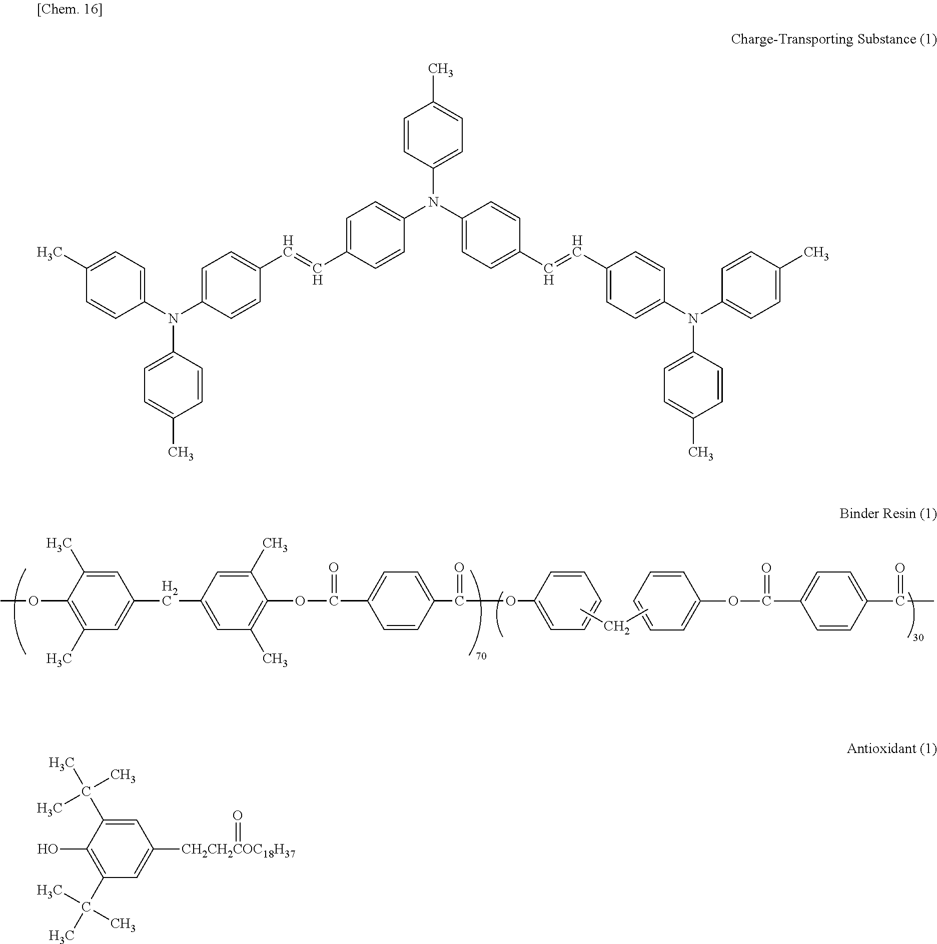

### Example 2

### Electrophotographic Photoreceptor X2

A photoreceptor X2 was produced according to the same process as in Example 1 except that, in Example 1, the amine compound was changed to the above-exemplified compound (1)-19.

### Example 3

### Electrophotographic Photoreceptor X3

A photoreceptor X3 was produced according to the same process as in Example 1 except that, in Example 1, the amine compound was changed to the above-exemplified compound (1)-28.

### Example 4

### Electrophotographic Photoreceptor X4

A photoreceptor X4 was produced according to the same process as in Example 1 except that, in Example 1, the amine compound was changed to the above-exemplified compound (1)-30.

### Comparative Example 1

### Electrophotographic Photoreceptor Y1

A photoreceptor Y1 was produced according to the same process as in Example 1 except that, in Example 1, the amine compound was not added.

### Comparative Example 2

### Electrophotographic Photoreceptor Y2

A photoreceptor Y2 was produced according to the same process as in Example 1 except that, in Example 1, the amine compound was not added and 8 parts of the antioxidant (1) was used.

### Comparative Example 2

### Electrophotographic Photoreceptor Y2

A photoreceptor Y3 was produced according to the same process as in Example 1 except that, in Example 1, the amine compound was not added and 8 parts of an antioxidant (2) mentioned below was used.

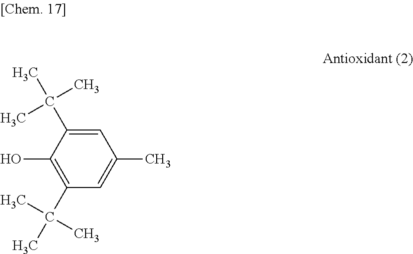 [SMILES: Cc1cc(C(C)(C)C)c(O)c(C(C)(C)C)c1]

### Example 5

### Electrophotographic Photoreceptor X5

A photoreceptor X5 was produced according to the same process as in Example 1 except that, in Example 1, the charge-transporting substance was changed to a charge-transporting substance (2) mentioned below (synthesized using palladium and according to the method of the above scheme 2).

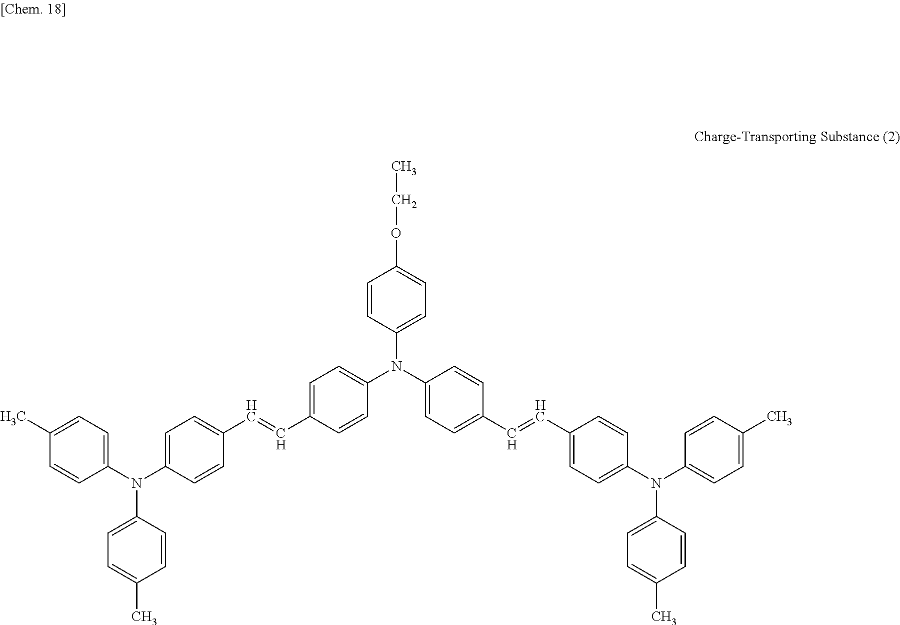

### Example 6

### Electrophotographic Photoreceptor X6

A photoreceptor X6 was produced according to the same process as in Example 5 except that, in Example 5, the amine compound was changed to the above-exemplified compound (1)-20.

### Example 7

### Electrophotographic Photoreceptor X7

A photoreceptor X7 was produced according to the same process as in Example 5 except that, in Example 5, the amine compound was changed to the above-exemplified compound (1)-28.

### Example 8

### Electrophotographic Photoreceptor X8

A photoreceptor X8 was produced according to the same process as in Example 5 except that, in Example 5, the amine compound was changed to the above-exemplified compound (1)-30.

### Comparative Example 4

### Electrophotographic Photoreceptor Y4

A photoreceptor Y4 was produced according to the same process as in Example 5 except that, in Example 5, the amine compound was not added.

### Reference Example 1

### Electrophotographic Photoreceptor Z1

A charge generation layer and an undercoat layer were formed according to the same process as in Example 1, in which, however, a charge transport layer was formed as follows. A liquid prepared by dissolving 50 parts of a charge-transporting substance (3) having a structure shown below, 100 parts of a binder resin (2) having a structure shown below (viscosity-average molecular weight: 30000), 1 part of the above-exemplified amine compound (1)-1, and, as a leveling agent, 0.05 parts of a silicone oil in 640 parts of a mixed solvent of tetrahydrofuran/toluene (8/2) was applied to the charge generation layer and dried at 125° C. for 20 minutes in such a manner that the coating film could be, after dried, 25 thereby producing a photoreceptor Z1.

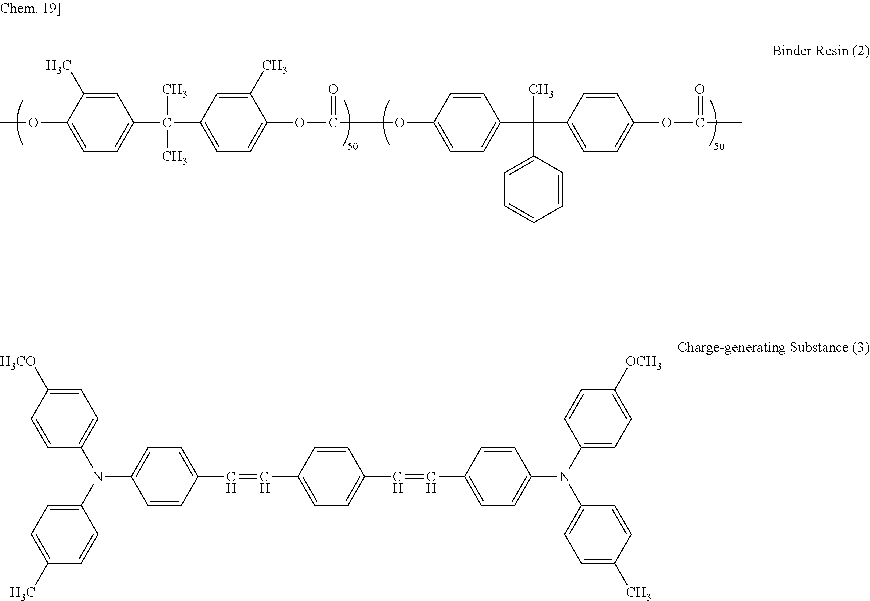

### Reference Example 2

### Electrophotographic Photoreceptor Z2

A photoreceptor Z2 was produced according to the same process as in Reference Example 1 except that, in Reference Example 1, the amine compound (1)-1 was not added.

### Reference Example 3

### Electrophotographic Photoreceptor Z3

A photoreceptor Z3 was produced according to the same process as in Reference Example 1 except that, in Reference Example 1, the amine compound was not added and 8 parts of the antioxidant (1) was used.

### Reference Example 4

### Electrophotographic Photoreceptor Z4

A photoreceptor Z4 was produced according to the same process as in Reference Example 1 except that, in Reference Example 1, the amine compound was not added and 16 parts of the antioxidant (1) was used.

### Reference Example 5

### Electrophotographic Photoreceptor Z5

A photoreceptor Z5 was produced according to the same process as in Reference Example 1 except that, in Reference Example 1, the charge-transporting substance was changed to a charge-transporting substance (4) having a structure shown below.

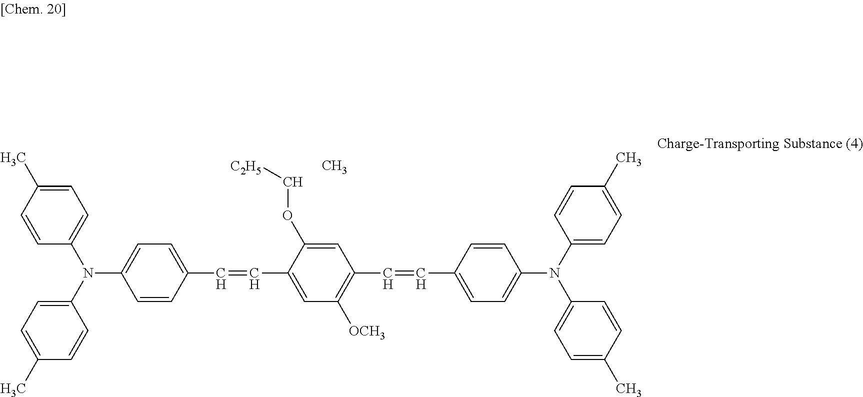

### Reference Example 6

### Electrophotographic Photoreceptor Z6

A photoreceptor Z6 was produced according to the same process as in Reference Example 5 except that, in Reference Example 5, the amine compound (1)-1 was not added.

### Reference Example 7

### Electrophotographic Photoreceptor Z7

A photoreceptor Z7 was produced according to the same process as in Reference Example 1 except that, in Reference Example 1, the charge-transporting substance was changed to a charge-transporting substance (5) having a structure shown below.

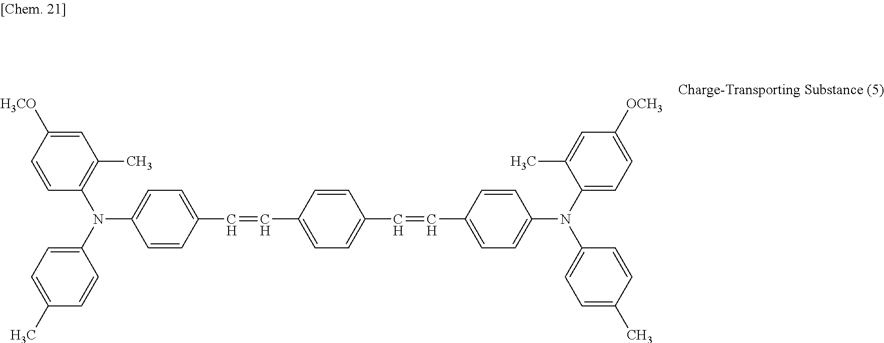 [SMILES: COc1ccc(N(c2ccc(C)cc2)c2ccc(C=Cc3ccc(C=Cc4ccc(N(c5ccc(C)cc5)c5ccc(OC)cc5C)cc4)cc3)cc2)c(C)c1]

### Reference Example 8

### Electrophotographic Photoreceptor Z8

A photoreceptor Z8 was produced according to the same process as in Reference Example 7 except that, in Reference Example 7, the amine compound (1)-1 was not added.

### Reference Example 9

### Electrophotographic Photoreceptor Z9

A photoreceptor Z9 was produced according to the same process as in Comparative Example 1 except that, in Comparative Example 1, the charge-transporting substance was changed to a charge-transporting substance (6) having a structure shown below.

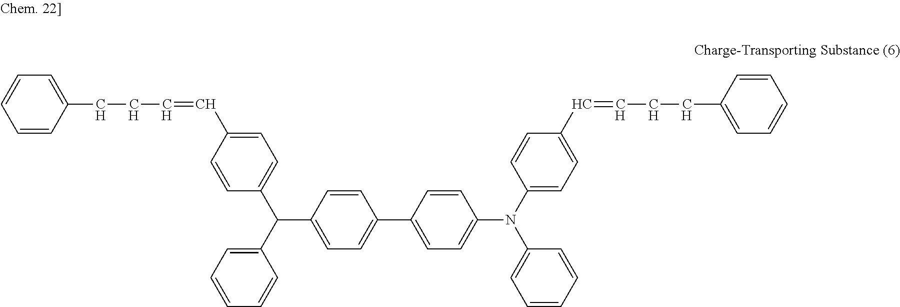 [SMILES: C(=Cc1ccc(C(c2ccccc2)c2ccc(-c3ccc(N(c4ccccc4)c4ccc(C=CCCc5ccccc5)cc4)cc3)cc2)cc1)CCc1ccccc1]

### Reference Example 10

### Electrophotographic Photoreceptor Z10

A photoreceptor Z10 was produced according to the same process as in Comparative Example 1 except that, in Comparative Example 1, the charge-transporting substance was changed to a charge-transporting substance (7) having a structure shown below.

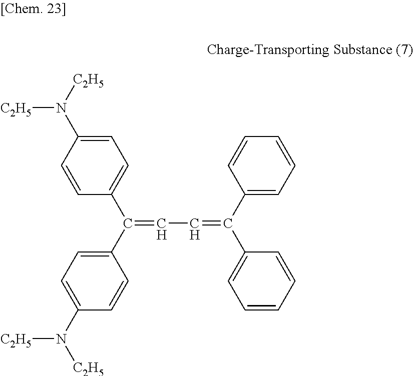 [SMILES: CCN(CC)c1ccc(C(=CC=C(c2ccccc2)c2ccccc2)c2ccc(N(CC)CC)cc2)cc1]

(Reference Example 11

### Electrophotographic Photoreceptor Z11

A photoreceptor Z11 was produced according to the same process as in Reference Example 9 except that, in Reference Example 9, the charge-transporting substance was changed to a charge-transporting substance (8) having a structure shown below.

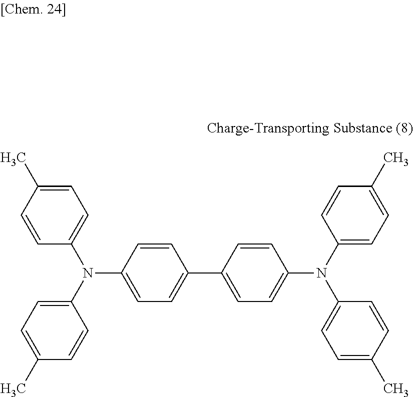 [SMILES: Cc1ccc(N(c2ccc(C)cc2)c2ccc(-c3ccc(N(c4ccc(C)cc4)c4ccc(C)cc4)cc3)cc2)cc1]

### Reference Example 12

### Electrophotographic Photoreceptor Z12

A photoreceptor Z12 was produced according to the same process as in Reference Example 9 except that, in Reference Example 9, the charge-transporting substance was changed to a charge-transporting substance (9) having a structure shown below.

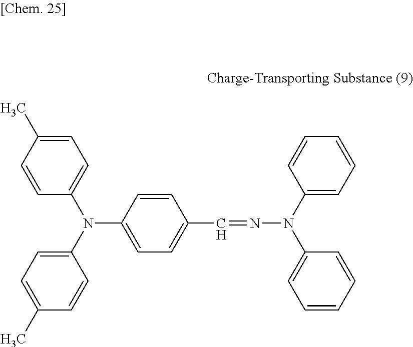 [SMILES: Cc1ccc(N(c2ccc(C)cc2)c2ccc(C=NN(c3ccccc3)c3ccccc3)cc2)cc1]

### Comparative Example 5

### Electrophotographic Photoreceptor Y5

A photoreceptor Y5 was produced according to the same process as in Comparative Example 10 except that, in Comparative Example 10, 1 part of the amine compound (1)-1 was added.

### Example 10

### Electrophotographic Photoreceptor X10

A photoreceptor X10 was produced according to the same process as in Example 5 except that, in Example 5, the amount of the amine compound to be added was changed to 0.1 parts.

### Example 11

### Electrophotographic Photoreceptor X11

A photoreceptor X11 was produced according to the same process as in Example 5 except that, in Example 5, the amount of the amine compound to be added was changed to 3 parts.

The HOMO energy level Ehomo and the molecular weight of the charge-transporting substances (1) to (9) are shown in Table 2.

TABLE 2

| Charge-Transporting | | |
|---|---|---|
| Substance | E_homo (eV) | Molecular Weight |
| (1) | −4.40 | 868 |
| (2) | −4.35 | 884 |
| (3) | −4.44 | 705 |
| (4) | −4.52 | 775 |
| (5) | −4.51 | 733 |
| (6) | −4.64 | 745 |
| (7) | −4.33 | 501 |
| (8) | −4.55 | 545 |
| (9) | −4.56 | 468 |

### <Measurement of Mobility>

Of the obtained photoreceptors X1, X5, Y6, Y8, X11, Y10, Y11 and Y13, the mobility at 5° C. and 21° C. and at a field intensity of 3×10⁵ (V/cm) was measured according to a TOF (time-of-flight) method. The results are shown in Table 3.

### <Evaluation of Electric Characteristics of Photoreceptor>

The obtained photoreceptor was wound around an aluminium cylinder having a diameter of 80 mm, and set in an electrophotographic characteristics evaluation device produced according to the measurement standards in Society of Electrophotography of Japan (described in Basis and Application of Electrophotography Technique Continued, edited by Society of Electrophotography of Japan, published by Corona Publishing, pp. 404-405), and evaluated for the electric characteristics thereof according to a cycle of charging, exposure, potential measurement and neutralization. The results are shown in Table 3. The photoreceptor was so charged that the initial surface potential thereof at 25° C. and a humidity of 50% could be −700 V, and exposed to a 780 nm monochromatic light from a halogen lamp via an interference filter at a sufficient energy level of 1.0 μJ/cm². The surface potential (hereinafter referred to as VLm) of the photoreceptor was measured. The value is shown in Table 3.

### <Evaluation of Ozone Resistance>

A method of ozone exposure test is described. Using Kawaguchi Electric's EPA8200, the photoreceptor obtained in Examples and Comparative Examples was charged by applying a current of 25 μA to the corotron charger, and the charged value was referred to as V1. The photoreceptors were exposed to ozone at from 300 to 400 volume ppm concentration, as measured through suction measurement using an ozone detector, Gastec's 18M, for 3 to 5 hours a day and for 2 days. After the exposure, the charged value was measured similarly, and was referred to as V2. The charge retention rate (V2/V1×100) (%) before and after exposure to ozone is shown in Table 3.

TABLE 3

| | | | Charge- | | | | | Charge |
|---|---|---|---|---|---|---|---|---|
| | | Binder | Transporting | Amine | | Mobility | VLm | Retention |
| | Photoreceptor | Resin | Substance | Compound | Antioxidant | (cm²/vs) | (−V) | Rate (%) |
| Example 1 | X1 | (1) | (1) | (1)-1 | (1) 4 parts | 9.79 × 10⁻⁶ | 20 | 94 |
| Example 2 | X2 | | | (1)-19 | (1) 4 parts | — | 20 | 93 |
| Example 3 | X3 | | | (1)-28 | (1) 4 parts | — | 21 | 89 |
| Example 4 | X4 | | | (1)-30 | (1) 4 parts | — | 20 | 91 |
| Comparative Example 1 | Y1 | | | none | (1) 4 parts | — | 19 | 74 |
| Comparative Example 2 | Y2 | | | none | (1) 8 parts | — | 24 | 80 |
| Comparative Example 3 | Y3 | | | none | (2) 8 parts | — | 35 | 83 |
| Example 5 | X5 | | (2) | (1)-1 | (1) 4 parts | 7.35 × 10⁻⁶ | 23 | 90 |
| Example 6 | X6 | | | (1)-20 | (1) 4 parts | — | 23 | 88 |
| Example 7 | X7 | | | (1)-28 | (1) 4 parts | — | 24 | 89 |
| Example 8 | X8 | | | (1)-30 | (1) 4 parts | — | 23 | 89 |
| Comparative Example 4 | Y4 | | | none | (1) 4 parts | — | 22 | 69 |
| Reference Example 1 | Z1 | (2) | (3) | (1)-1 | none | — | 10 | 92 |
| Reference Example 2 | Z2 | | | none | none | — | 10 | 82 |
| Reference Example 3 | Z3 | | | none | (1) 8 parts | 1.14 × 10⁻⁵ | 14 | 85 |
| Reference Example 4 | Z4 | | | none | (1) 16 parts | — | 18 | 86 |
| Reference Example 5 | Z5 | | (4) | (1)-1 | none | — | 21 | 92 |
| Reference Example 6 | Z6 | | | none | none | 1.89 × 10⁻⁶ | 18 | 79 |
| Reference Example 7 | Z7 | | (5) | (1)-1 | none | 1.04 × 10⁻⁵ | 11 | 95 |
| Reference Example 8 | Z8 | | | none | none | — | 10 | 73 |
| Reference Example 9 | Z9 | (1) | (6) | none | (1) 4 parts | 6.77 × 10⁻⁶ | 87 | 96 |
| Reference Example 10 | Z10 | | (7) | none | (1) 4 parts | 5.45 × 10⁻⁷ | 49 | 98 |
| Reference Example 11 | Z11 | (2) | (8) | none | none | — | 24 | 89 |
| Reference Example 12 | Z12 | | (9) | none | none | 1.54 × 10⁻⁶ | 56 | 90 |
| Comparative Example 5 | Y5 | (1) | (6) | (1)-1 | none | — | 97 | 98 |
| Example 10 | X10 | (1) | (2) | (1)-1 | (1) 4 parts | — | 19 | 88 |
| Example 11 | X11 | | | (1)-1 | (1) 4 parts | — | 20 | 95 |

<Measurement of Surface Resistance Value before and after Exposure to Ozone>

The charge transport layer liquid prepared in Example 1, Comparative Example 1, Comparative Example 5 and Reference Example 9 was applied onto a 100-μm PET film in such a manner that the thickness of the coating film could be, after dried, 20 μm. Thus prepared, the surface resistance value of the charge transport layer sample of a photoreceptor was measured under the condition mentioned below, using a high resistivity meter, Hiresta-UP, MCP-HT450 (by Mitsubishi Chemical).

### Probe: UR100

### Applied Voltage: 1000 V

Measurement Time: 60 seconds

Subsequently, the sample was exposed to ozone at 400 volume ppm concentration, as measured through suction measurement using an ozone detector, Gastec's 18M, for 90 minutes, and the surface resistance value thereof was measured in the same manner as above. The surface resistance value before and after exposure to ozone is shown in Table 4.

TABLE 4

| Charge Transport Layer | before exposure to | after exposure to |
|---|---|---|
| Liquid | ozone (Ω) | ozone (Ω) |
| Liquid in Example 1 | 1 × 10¹⁴ or more | 2.87 × 10¹³ |
| Liquid in Comparative | 1 × 10¹⁴ or more | 5.30 × 10¹² |
| Example 1 | | |
| Liquid in Comparative | 1 × 10¹⁴ or more | 1 × 10¹⁴ or more |
| Example 10 | | |
| Liquid in Comparative | 1 × 10¹⁴ or more | 1 × 10¹⁴ or more |
| Example 14 | | |

From the data in Table 4, it is known that only the case where the charge-transporting substance in the present invention is used as combined with the specific amine compound realizes the effect of improving the surface resistance retentivity. Since the surface resistance does not lower, the photoreceptor is free from image deletion and image blurring even though the surface thereof is charged by high voltage application thereto.

### Example 12

### Electrophotographic Photoreceptor X12

A photoreceptor X12 was produced according to the same process as in Example 1 except that, in Example 1, the binder resin (1) was changed to the binder resin (3).

### Comparative Example 6

### Electrophotographic Photoreceptor Y6

A photoreceptor Y6 was produced according to the same process as in Example 1 except that, in Example 12, the amine compound was not added and 8 parts of the compound of the antioxidant (1) was added.

### Comparative Example 7

### Electrophotographic Photoreceptor Y7

A photoreceptor Y7 was produced according to the same process as in Example 1 except that, in Example 12, the amine compound was not added and 8 parts of the compound of the antioxidant (2) was added.

### Comparative Example 8

### Electrophotographic Photoreceptor Y8

A photoreceptor Y8 was produced according to the same process as in Example 1 except that, in Example 12, the amine compound was not added.

### Example 13

### Electrophotographic Photoreceptor X13

A photoreceptor X13 was produced according to the same process as in Example 12 except that, in Example 12, the charge-transporting substance was changed to the charge-transporting substance (2) having the structure mentioned above.

### Comparative Example 9

### Electrophotographic Photoreceptor Y9

A photoreceptor Y9 was produced according to the same process as in Example 12 except that, in Example 12, the charge-transporting substance was changed to the charge-transporting substance (6) having the structure mentioned above.

### Comparative Example 10

### Electrophotographic Photoreceptor Y10

A photoreceptor Y10 was produced according to the same process as in Example 12 except that, in Example 12, the charge-transporting substance was changed to a charge-transporting substance (10) having a structure mentioned below.

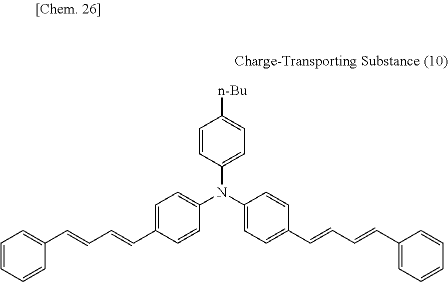

### Comparative Example 11

### Electrophotographic Photoreceptor Y11

A photoreceptor Y11 was produced according to the same process as in Example 12 except that, in Example 12, the charge-transporting substance was changed to a charge-transporting substance (11) having a structure mentioned below.

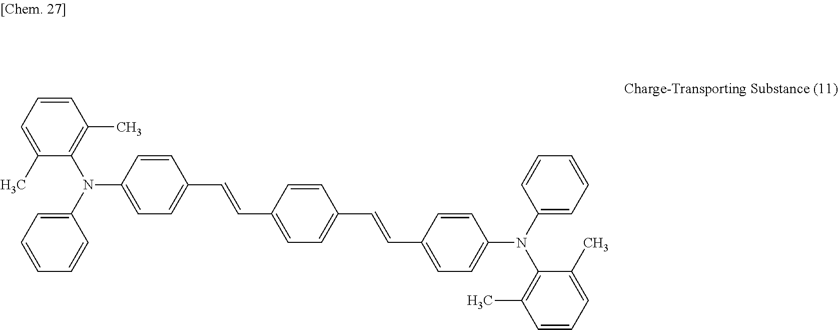 [SMILES: Cc1cccc(C)c1N(c1ccccc1)c1ccc(/C=C/c2ccc(/C=C/c3ccc(N(c4ccccc4)c4c(C)cccc4C)cc3)cc2)cc1]

<Measurement of Surface Resistance Value before and after Photoexposure>

The charge transport layer liquid prepared in Examples 12 and 13, and Comparative Examples 6 to 11 was applied onto a 100-μm PET film in such a manner that the thickness of the coating film could be, after dried, 20 μm. Thus prepared, the surface resistance value of the charge transport layer sample of a photoreceptor was measured under the condition mentioned below, using a high resistivity meter, Hiresta-UP, MCP-HT450 (by Mitsubishi Chemical).

### Probe: UR100

### Applied Voltage: 1000 V

Measurement Time: 60 seconds

Subsequently, the sample was exposed to light from a white fluorescent lamp (National's FL20SW) in such a controlled manner that the light intensity on the surface of the photoreceptor could be 2000 lux, for 10 minutes, and the surface resistance value of the sample was again measured in the same manner. Table 5 shows the surface resistance value before and after photoexposure.

TABLE 5

| | | | | | | | Surface |
|---|---|---|---|---|---|---|---|
| | | | | | | | Resistance |
| | | | Charge- | Amine | | VLm | Change |
| | Photoreceptor | Binder | Transporting | Compound | Antioxidant | (−V) | (×10¹² Ω) |
| Example 12 | X12 | (3) | (1) | (1)-1 | (1) 4 parts | 44 | −0.06 |
| Comparative | Y6 | | (1) | none | (1) 8 parts | 27 | −10.9 |
| Example 6 | | | | | | | |
| Comparative | Y7 | | (1) | none | (2) 8 parts | 41 | −18.5 |
| Example 7 | | | | | | | |
| Comparative | Y8 | | (1) | none | none | 21 | −7.39 |
| Example 8 | | | | | | | |
| Example 13 | X13 | | (2) | (1)-1 | (1) 4 parts | 24 | −6.58 |
| Comparative | Y9 | | (6) | (1)-1 | (1) 4 parts | 240 | −25.4 |
| Example 9 | | | | | | | |
| Comparative | Y10 | | (10) | (1)-1 | (1) 4 parts | 209 | −16.3 |
| Example 10 | | | | | | | |
| Comparative | Y11 | | (11) | (1)-1 | (1) 8 parts | 63 | −9.65 |
| Example 11 | | | | | | | |

### Example 14

### Photoreceptor Drum A1

The surface of an aluminium cylinder having an outer diameter of 30 mm and a length of 285 mm, which had been mirror-finished, was processed for anodic oxidation, and thereafter processed for sealing treatment with a sealing agent comprising nickel acetate as the main ingredient, thereby forming an anodic oxide film (alumite film) having a thickness of about 6 μm. The cylinder having the alumite film formed thereon was dipped in the dispersion for charge generation layer that had been prepared in Example 5 so as to be coated with the dispersion, thereby providing thereon a charge generation layer in such a manner that the thickness of the coating film could be, after dried, 0.3 g/m² (about 0.3 μm). Next, this was dipped in the charge transport layer liquid that had been prepared in Example 5 so that the charge generation layer thereof could be coated with the liquid, thereby forming a charge transport layer in such a manner that the thickness thereof could be, after dried, 18 μm. Thus obtained, the photoreceptor is referred to as a photoreceptor drum A1.

### Comparative Example 12

### Photoreceptor Drum A2

A photoreceptor drum A2 was produced according to the same process as in Example 13, except that the charge transport layer liquid used in Comparative Example 4 was used herein.

### <Image Evaluation>

The produced photoreceptor drum A1 or A2 was mounted on a full-color printer, Epson's LP-3000C, in which 10,000 copies were continuously printed at YMCK 5% each. As a result, the thinning of the photosensitive layer was about 1.5 μm or so both in A1 and A2. However, in the case of using the photoreceptor drum A2, the dot reproducibility began to worsen after formation of about 4,000 copies. In the case of using the photoreceptor drum A1, no abnormality in image formation occurred after up to formation of 10,000 copies.

While the present invention has been described in detail and with reference to specific embodiments thereof, it will be apparent to one skilled in the art that various changes and modifications can be made therein without departing from the spirit and scope thereof. The present application is based on a Japanese patent application (Patent Application 2013-062631) filed Mar. 25, 2013, and the contents thereof are incorporated herein by reference.

### REFERENCE SIGNS LIST

1 Photoreceptor (electrophotographic photoreceptor)
2 Charging Device (charging roller; charging part)
3 Exposure Device (exposure part)
4 Development Device (development part)
5 Transfer Device
6 Cleaning Device
7 Fixation Device
41 Development Tank
42 Agitator
43 Feed Roller
44 Development Roller
45 Control Member
71 Upper Fixation Member (fixation roller)
72 Lower Fixation Member (fixation roller)
73 Heating Device
T Toner
P Recording Paper (paper, medium)

1. An electrophotographic photoreceptor comprising at least a photosensitive layer on a conductive support, wherein the photosensitive layer contains a compound represented by the following formula (1) and a charge-transporting substance represented by the following formula (2): 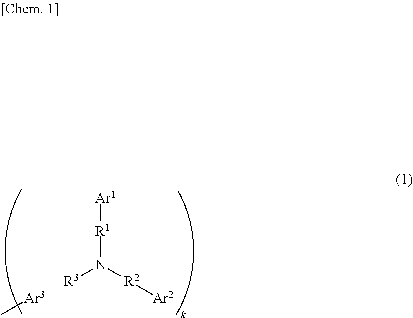
(In the formula (1), R¹, R² and R³ each independently represent an alkylene group having 3 or less carbon atoms and optionally having a substituent, Ar¹ and Ar² each independently represent a hydrogen atom, an alkyl group optionally having a substituent, or an aryl group optionally having a substituent, Ar³ represents an aryl group optionally having a substituent, and k indicates an integer of 1 or 2.) 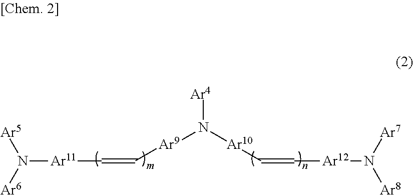
(In the formula (2), Ar⁴ to Ar⁸ each independently represent an aryl group optionally having a substituent, Ar⁹ to Ar¹² each independently represent an arylene group optionally having a substituent, and m and n each independently indicate an integer of from 1 to 3.)

2. The electrophotographic photoreceptor according to claim 1, wherein, in the formula (2), Ar⁴ to Ar⁸ each independently represent an aryl group optionally having an alkyl group or an alkoxy group, Ar⁹ to Ar¹² each independently represent a 1,4-phenylene group optionally having a substituent, and m and n are 1.)

3. The electrophotographic photoreceptor according to claim 1, wherein, in the formula (2), Ar⁴ represents an aryl group having an alkoxy group, an aryloxy group or an aralkyloxy group, and Ar⁵ to Ar⁸ each independently represent an aryl group optionally having an alkyl group.

4. The electrophotographic photoreceptor according to claim 1, wherein an amount of the compound represented by the formula (1) is from 0.03 parts by mass to 5 parts by mass relative to 100 parts by mass of a total amount of the charge-transporting substance.

5. The electrophotographic photoreceptor according to claim 1, wherein the charge-transporting substance represented by the formula (2) is one to be obtained through coupling reaction of a halogen atom-having triphenylamine derivative and an aniline compound.

6. The electrophotographic photoreceptor according to claim 1, wherein the charge-transporting substance represented by the formula (2) contains palladium.

7. An electrophotographic cartridge comprising the electrophotographic photoreceptor of claim 1, and at least one means selected from a charging means of charging the electrophotographic photoreceptor, an imagewise exposure means of imagewise exposing the charged electrophotographic photoreceptor to light to form an electrostatic latent image, a development means of developing the electrostatic latent image with a toner, a transfer means of transferring the toner to a transferred medium, and a cleaning means of collecting the toner having adhered to the electrophotographic photoreceptor.

8. An image formation device comprising the electrophotographic photoreceptor of claim 1, a charging means of charging the electrophotographic photoreceptor, an exposure means of exposing the charged electrophotographic photoreceptor to light to form an electrostatic latent image, a development means of developing the electrostatic latent image with a toner, a transfer means of transferring the toner to a transferred medium, and a fixation means of fixing the toner transferred to the transferred medium.
